(19) United States
(12) Patent Application Publication
(10) Pub. No.: US 2026/0119851 A1
(43) Pub. Date: Apr. 30, 2026

(54) SYSTEMS AND METHODS FOR MODELING ASYNCHRONOUS TIME SERIES WITH LARGE LANGUAGE MODELS

(71) Applicant: Royal Bank of Canada, Toronto (CA)

(72) Inventors: Shubham Gupta, Montreal (CA); Thibaut Durand, Vancouver, CA (US); Graham Taylor, Guelph (CA); Lilian Wong Bialokozowicz, Vancouver (CA)

(21) Appl. No.: 19/336,002

(22) Filed: Sep. 22, 2025

Related U.S. Application Data
(60) Provisional application No. 63/713,225, filed on Oct. 29, 2024.

(51) Int. Cl. G06N 3/0475; G06N 3/08; G06Q 30/015

(52) U.S. Cl. CPC G06N 3/0475; G06N 3/08; G06Q 30/015

(57) ABSTRACT

Methods, systems, and techniques for modeling asynchronous time series data with large language models are disclosed. In one aspect, a computer-implemented method comprises: obtaining an asynchronous time series of event data, the asynchronous time series comprising events and corresponding times associated with the events; processing the asynchronous time series of event data to generate an input series comprising a textual description of each of the events and a time associated with each of the events; generating a prompt to a large language model, the prompt comprising the input series and specifying a task to be performed on the input series; and receiving an output from the large language model in response to the prompt.

### CROSS-REFERENCE TO RELATED APPLICATIONS

This application claims priority to and the benefit of U.S. Provisional Patent Application No. 63/713,225, filed on Oct. 29, 2024, the entire contents of which is incorporated by reference herein for all purposes.

### TECHNICAL FIELD

The present disclosure relates to methods, systems, and techniques for modeling asynchronous time series data with large language models.

### BACKGROUND

Deep learning models have significantly revolutionized techniques for time series modeling, and even more so with the introduction of transformers. However, there are often limitations due to the scarcity of training data, overfitting in specific domains, and the highly specialized architectural designs. In response to those challenges, Large Language Models (LLMs) have emerged as a powerful and promising direction to model time series data. For example, LLMs can be used as time series forecasters when the input time series is encoded as a string of numeric digits by casting the time series forecasting problem as a next-token prediction in text, hence unlocking the use of powerful pre-trained models.

An asynchronous time series (also named temporal event sequence or continuous-time event sequence) is a temporally ordered set of events that describe the progression of actions or occurrences. Asynchronous time series are ubiquitous in daily life, such as healthcare, finance, e-commerce, and social media. In each of those domains, the prediction of next events play a crucial role. However, unlike time series which carry regular time stamps, asynchronous time series data is a sequence of events that do not follow any time pattern and modeling them has presented new challenges.

Accordingly, methods, systems, and techniques for modeling asynchronous time series data remain desirable.

### SUMMARY

According to a first aspect, there is provided a computer-implemented method, comprising: obtaining an asynchronous time series of event data, the asynchronous time series comprising events and corresponding times associated with the events; processing the asynchronous time series of event data to generate an input series comprising a textual description of each of the events and a time associated with each of the events; generating a prompt to a large language model, the prompt comprising the input series and specifying a task to be performed on the input series; and receiving an output from the large language model in response to the prompt.

In some aspects, the time associated with a particular event in the input series comprises an inter-arrival time between the particular event and a previous event.

In some aspects, the input series is expressed as a sequence of pairs.

In some aspects, the time is presented first in the pair, followed by the textual description of the event.

In some aspects, the task to be performed on the input series is one of: forecasting, data imputation, and anomaly detection.

In some aspects, generating the prompt comprises prepending a prefix obtained from a trained prompt.

In some aspects, the method further comprises obtaining the trained prompt by: obtaining training data for training the large language model; obtaining a trainable prompt having a prefix; generating a training prompt comprising the training data and a randomly selected prefix from the prefix of the trainable prompt; and training the large language model and the trainable prompt using the training prompt.

In some aspects, the asynchronous time series of event data comprises customer interactions with a financial institution.

In some aspects, the asynchronous time series of event data comprises events associated with a financial account.

In some aspects, the method further comprises generating an alert based on the output from the large language model.

In accordance with another aspect of the present disclosure, there is provided a computer-implemented method, comprising: obtaining training data for training a large language model; obtaining a trainable prompt having a prefix for training the large language model to perform a task; generating a training prompt comprising the training data and a randomly selected prefix from the prefix of the trainable prompt; and training the large language model and the trainable prompt using the training prompt.

In some aspects, the randomly selected prefix is obtained by selecting a particular prefix length from a prefix length of the trainable prompt using a probability distribution of prefix lengths.

In some aspects, the probability distribution is a uniform distribution.

In some aspects, the task that the large language model is trained to perform is one of: forecasting, data imputation, and anomaly detection.

In some aspects, the training data comprises an asynchronous time series of event data.

In accordance with another aspect of the present disclosure, use of the large language model and the trainable prompt trained in accordance with the computer-implemented method of any one of the above aspects is disclosed for performing the task on an input series.

In accordance with another aspect of the present disclosure, there is provided a system, comprising: a processor; and a non-transitory computer-readable medium having computer-executable instructions stored thereon which, when executed by the processor, configure the system to perform the computer-implemented method of any one of the above aspects.

In accordance with another aspect of the present disclosure, there is provided a non-transitory computer-readable medium having computer-executable instructions stored thereon which, when executed by a processor, configure the processor to perform the computer-implemented method of any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for modeling asynchronous time series data using a large language model (LM).

FIG. 2 is a block diagram of a server comprising part of the system depicted in FIG. 1.

FIG. 3 shows a method of using a LLM to perform a task on asynchronous time series data.

FIG. 4 shows an example structure of a prompt used for modeling asynchronous time series data with large language models.

FIGS. 5A-D show exemplary representations of tasks performed by the large language model.

FIGS. 6A and 6B show representations of training the large language model using trainable prompts.

FIG. 7 shows a method of applying stochastic soft prompts for LLM adaptation.

FIG. 8 shows graphs depicting a distribution of event types for four of the datasets used herein;

FIG. 9 shows an analysis of learned token representations of Stochastic Soft Prompt (StoP) and Soft Prompt (SP);

FIG. 10 shows graphs comparing prefixes of StoP prompts to SP prompts; and

FIG. 11 shows graphs comparing performance between stochasticity and prefix picking in StoP.

FIG. 12 shows histogram plots comparing performance between baselines.

FIG. 13 shows histogram plots comparing performance between model sizes.

FIG. 14 shows graphs of performance variance over the number of examples given.

FIG. 15 shows graphs of StoP tokens and similarities.

### DETAILED DESCRIPTION

In accordance with the present disclosure, methods, systems, and techniques for modeling asynchronous time series data with large language models are disclosed.

The following notations are used herein: n are observed events over a fixed time interval [0, T), with each event being denoted as (e, t), where e∈E is the event type (or attributes) and E represents the space of event types. An asynchronous time series is a sequence of events x₁:n=((e₁, t₁), (e₂, t₂), . . . , (eₙ, tₙ)) where tᵢ is an increasing sequence in [0, T) that does not necessarily observe any periodicity. A common alternative to the event time tᵢ is the inter-arrival time τⱼ:=tⱼ−tⱼ₋₁. Event time and inter-arrival time are considered isomorphic and often used interchangeably. In the present disclosure there is very little constraint on E and in principle, the model still works even if E is infinite. What is needed is to be able to compute a vectorial representation of the event type/attributes, which is achieved through the LLM's learned input embeddings disclosed herein.

Language modeling is a widely used task to train LLMs where the goal is predicting the next word or character in a document. Language models are designed to work on a sequence of m tokens, where each token belongs to a vocabulary. A tokenizer transforms the input text data into a sequence of tokens. The tokenization process is important and can significantly impact performances, for it directly influences how patterns form within tokenized sequences and the types of operations that language models can learn.

A new approach to model asynchronous time series with LLMs is disclosed herein which can be used to solve different tasks, including:
(1) Forecasting (also known as next event prediction): Given a history of events x_{1:m} from an asynchronous time series, the model is tasked with predicting the next event xₘ₊₁.
(2) Data imputation: One of the events xⱼ of the series is randomly chosen and masked, and the model is tasked with filling in the gap.
(3) Anomaly detection: One event xⱼ of the series is randomly chosen and its event type eⱼ is replaced randomly by another event type e′. The model is tasked with identifying this out-of-place element.

To enable the model to solve these tasks for asynchronous time series data, two aspects of the present disclosure are described for modeling asynchronous time series data.

In one aspect of the present disclosure, a framework for representing asynchronous time series is disclosed where the sequence of events is encoded as a string comprising a textual description of event type and an associated time to leverage use of an LLM to perform various tasks on such data. This framework is referred to herein as LASTS, a novel framework to adapt LLMs to Asynchronous Time Series data while keeping the backbone of the model intact. Thus, unlike existing techniques that attempt to model asynchronous time series, the model works in an open world setting and can process new event types without retraining. Experimental results are provided that demonstrate that this framework can adapt LLMs to tasks like forecasting, imputation, and anomaly detection. The framework achieves strong performances that outperforms leading state-of-the-art methods in multiple settings, including zero-shot learning, few-shot learning, and fine-tuning adaptation.

In at least some embodiments herein, a computer-implemented method comprises: obtaining an asynchronous time series of event data, the asynchronous time series comprising events and corresponding times associated with the events; processing the asynchronous time series of event data to generate an input series comprising a textual description of each of the events and a time associated with each of the events; generating a prompt to a large language model, the prompt comprising the input series and specifying a task to be performed on the input series; and receiving an output from the large language model in response to the prompt.

In another aspect of the present disclosure, a hierarchical soft prompting framework is disclosed. This framework is referred to herein as Stochastic Soft Prompt (StoP), and is an interpretable adaptation of soft prompting as a parameter-efficient way to adapt an LLM. During training, the soft prompts are randomly truncated to learn more diverse representations, and to enhance the model's adaptability to carry out various downstream tasks, while also improving training performance and computational efficiency. The StoP framework is demonstrated to be useful for adapting an LLM to model an asynchronous time series, however it will be appreciated that the StoP framework can provide benefits for other use cases.

In at least some embodiments herein, a computer-implemented method comprises: obtaining training data for training a large language model; obtaining a trainable prompt having a prefix for training the large language model to perform a task; generating a training prompt comprising the training data and a randomly selected prefix from the prefix of the trainable prompt; and training the large language model and the trainable prompt using the training prompt.

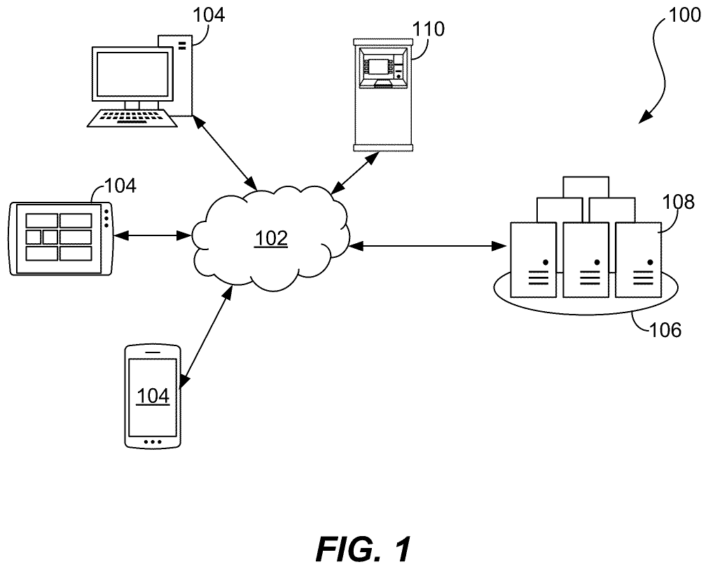

Referring now to FIG. 1, there is shown a computer network 100 that comprises an example embodiment of a system for modeling an asynchronous time series using a large language model. The computer network 100 comprises a wide area network 102 such as the Internet to which various devices are communicatively coupled. In the example depicted in FIG. 1, the user devices 104, an ATM 110, and data center 106 are communicatively coupled. The data center 106 comprises a number of servers 108 networked together to collectively perform various computing functions. The servers 108 may be distributed (cloud service).

In the example system depicted in FIG. 1, the servers 108 may as an example be configured to perform modeling of an asynchronous time series of events that occur between the user devices 104 and/or the ATM 110 and the servers 108. For example, in the context of a financial institution such as a bank, the data center 106 supports banking services. Customers may interact with the data center 106 via user devices 104 to access banking services, which may comprise interacting with a teller, an online platform, a call center, etc. Further, individuals may appear in person at the ATM 110 to withdraw money from bank accounts controlled by the data center 106. The servers 108 may collect or otherwise obtain data related to customer interactions, and can model an asynchronous time series of events to perform various prediction tasks, as described in more detail herein. For example, by monitoring customer service interactions, the servers 108 may predict a next action that the customer wants. As another example, by monitoring customer interactions with a lender, the servers 108 may predict whether a customer is in distress. As still another example, by monitoring debit or credit card interactions (e.g. events associated with a financial account), the servers 108 may detect anomalies.

It will be appreciated that there may be various use cases for modeling asynchronous time series data. It will also be appreciated to a person skilled in the art that the methods, systems, and techniques disclosed herein for modeling asynchronous time series data are not limited to applications in the financial sector. As described above, asynchronous time series data is ubiquitous in daily life and the capability to model such asynchronous time series data for performing various tasks can find applications in many industries/use cases.

Accordingly, it will be appreciated that asynchronous time series data can be obtained from a variety of sources and is not limited to user devices. For example, asynchronous time series data may be received from sensors, other computer devices, etc., and may be received or obtained in real-time, near-real-time, in batches, and/or offline.

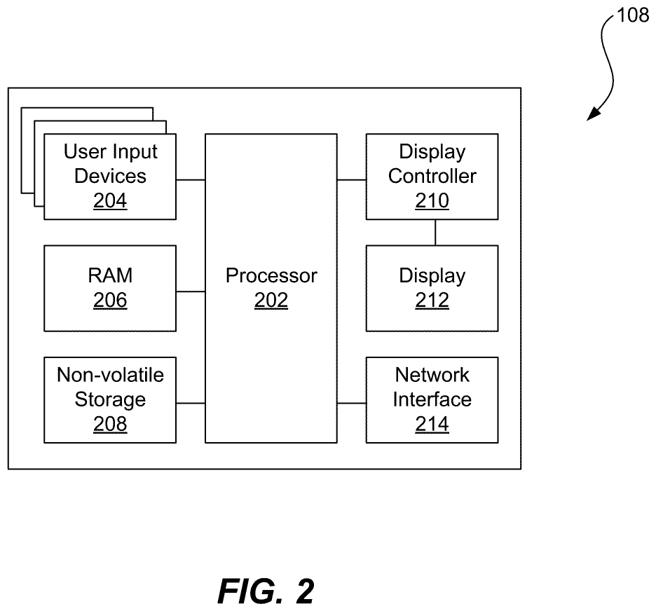

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for modeling asynchronous time series data using a large language model, such as is described in more detail herein below. Additionally or alternatively, the servers 108 may collectively perform that method using distributed computing. While the system depicted in FIG. 2 is described specifically in respect of one of the servers 108, analogous versions of the system may also be used for the user devices 104.

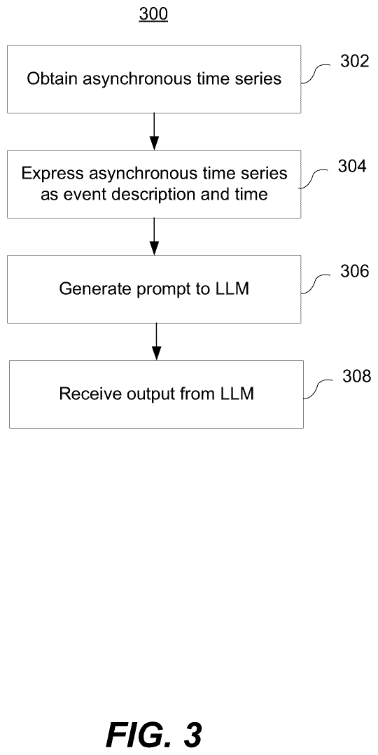

FIG. 3 shows a method 300 of using a large language model (LLM) to perform a task on asynchronous time series data. The method 300 may be implemented at the one or more servers 108 of the data center 106, for example. Instructions may be stored as computer program code, or non-transitory computer-readable instructions, which, when executed by the processor of the server, configures the server to implement the method 300 to use a LLM to perform a task on asynchronous time series data.

The method 300 comprises obtaining an asynchronous time series of event data (302). The asynchronous time series comprises events and corresponding times associated with the events. As a non-limiting example, the asynchronous time series of event data may comprise customer interactions with a financial institution. As another non-limiting example, the asynchronous time series of event data may comprise events associated with a financial account.

The asynchronous time series of event data is processed to generate an input series comprising a textual description of each of the events and a time associated with each of the events (304). The time associated with a particular event in the input series may be expressed as an inter-arrival time between the particular event and a previous event. The input series may be expressed as a sequence of pairs. In each pair, the time associated with an event may be expressed first, followed by the textual description of the event.

A prompt is generated for prompting the large language model (306). The prompt comprises the input series and specifies a task to be performed on the input series. The task to be performed on the input series may for example be one of: forecasting, data imputation, and anomaly detection. Generating the prompt may comprise prepending a prefix obtained from a trained prompt. A method of obtaining a trained prompt is described in more detail herein.

The output from the LLM is received (308). Depending on the application, an alert may be generated based on the output from the LLM, such as in response to a detected anomaly.

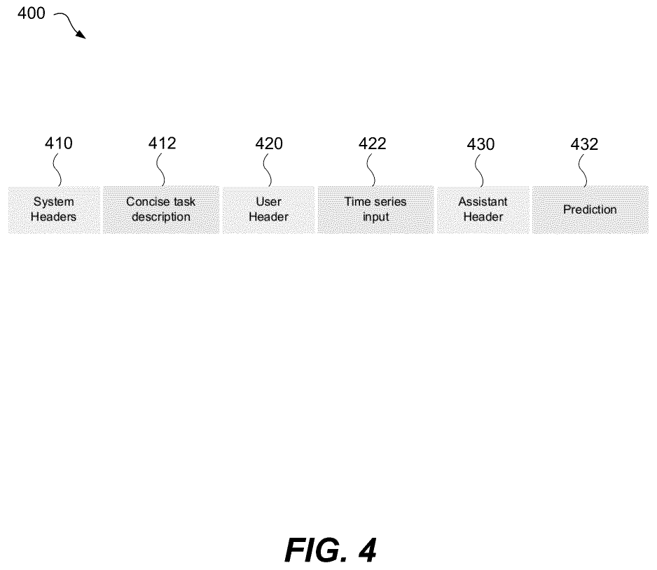

FIG. 4 shows an example structure of a prompt used for modeling asynchronous time series data with large language models.

As described above, unlike ordinary time series, often represented as sequences of numerical values, asynchronous time series are represented as sequences of events xᵢ=(eᵢ, tᵢ), where eᵢ is the event type, and tᵢ is a representation of the timestamp of this event. Normally, tᵢ is expressed as inter-arrival time, which is the time elapsed between event xᵢ₋₁ and xᵢ. Instead of reducing events to categories from a small set of options, the LASTS framework for representing an asynchronous time series as part of a prompt can retain an event type as a natural language description. An inter-arrival time is used as the time associated with a given event, however the expression of the times may take alternative forms.

As shown in FIG. 4, a prompt 400 in accordance with the present disclosure comprises three parts that can be mapped to a system-user-assistant structure for use as input for an LLM. That is, the prompt 400 comprises a system header(s) 410 and a corresponding system prompt 412 providing a concise task description, a user header 420 and a corresponding user prompt 422 comprising a time series input, and an assistant header 430 and an associated assistant prompt 432 comprising a prediction value.

The system prompt 412 introduces what an asynchronous time series is, provides a description of the task to be performed, and includes details about the underlying dataset.

The user prompt 422 represents the asynchronous time series as an input series expressed as a comma-separated sequence of tuples (in this case, pairs) (eᵢ, tᵢ), where eᵢ is the textual description of the event type and tᵢ is the inter-arrival time;

The assistant prompt 432 contains the correct event if performing LLM adaptation training, or is left to be generated by the LLM during inference.

The user prompt comprising the asynchronous time series data can be generated as described above. The system prompt may be specific to each task.

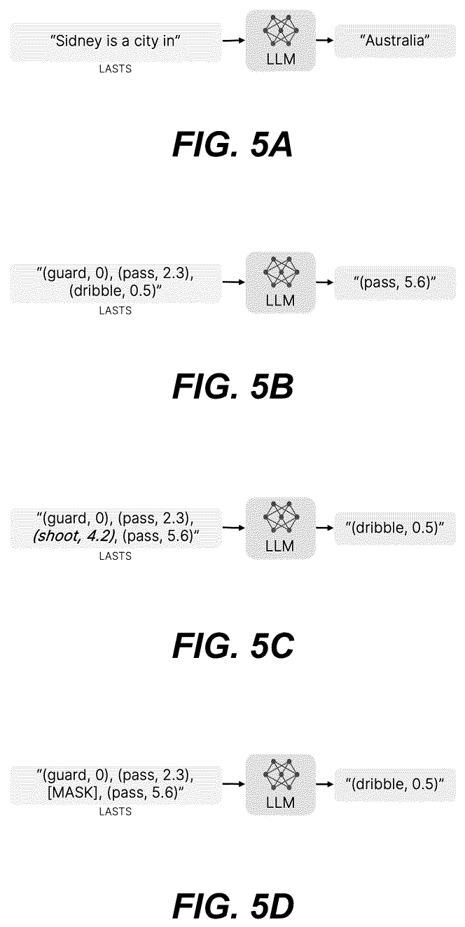

FIGS. 5A-D show exemplary representations of tasks that may be performed by the large language model. LLMs have shown great performances to solve NLP tasks by predicting the next token given a sequence of tokens (as represented by FIG. 5A). In accordance with the present disclosure, LLMs can be used to evaluate asynchronous time series data to solve tasks such as forecasting (as represented in FIG. 5B), anomaly detection (as represented in FIG. 5C) and imputation (as represented in FIG. 5D). In FIGS. 5B-D, each event is represented by the inter-arrival time of its occurrence and its textual description of event type. Unlike standard asynchronous time series models, the framework for modeling asynchronous time series data disclosed herein uses natural language event descriptions to extract richer semantic representations, resulting in greater accuracy.

Referring back to the prompt structure shown in FIG. 4, the system prompt may be very similar across different tasks to be performed by the LLM, except for the task specific portions of the prompt.

An example of a system prompt used for Forecasting is:

You are a helpful assistant. Your task is to complete an asynchronous time series. dataset description. Each series is given in the format (inter arrival time, action name). This indicates that the action name started inter arrival times milliseconds after the start of the previous action or the beginning of time if it's the first action. The allowable actions are: valid vocab. Given the first few elements of an asynchronous time series, your task is to provide the next action with its inter arrival time as (inter arrival time, action name). You generate all your response as a single python tuple. Be sure to provide only that one python tuple and nothing else.

An example of a system prompt used for Imputation is:

You are a helpful assistant. Your task is to find a missing value in an asynchronous time series. dataset description. Each series is given in the format (inter arrival time, action name). This indicates that the action name started inter arrival times milliseconds after the start of the previous action or the beginning of time if it's the first action. The allowable actions are: valid vocab. One of the elements in the series would be missing, marked by the word ‘MISSING’. Provide your answer as a single python tuple (inter arrival time, action name) which is your estimate of the missing element of the series. Be sure to give me that one missing python tuple as your response and nothing else.

An example of a system prompt used for Anomaly Detection is:

You are a helpful assistant. Your task is to find an anomalous value in an asynchronous time series. dataset description. Each series is given in the format (inter arrival time, action name). This indicates that the action name started inter arrival times milliseconds after the start of the previous action or the beginning of time if it's the first action. The allowable actions are: valid vocab. One of the elements in the series is an anomaly, and your task is to identify this element which doesn't belong in the series. Provide your answer as a single python tuple (inter arrival time, action name) which is an element from the series you think is an anomaly. Just give me that one anomalous python tuple from the series as your answer and nothing else.

In the above examples of system prompts, “dataset description” is a short one line description of the underlying dataset, for example: “The underlying dataset is derived from tagged human actions while cooking/preparing meals”.

Also, “valid vocab” is a comma separated list of allowable action descriptions, if it is chosen to provide this list and if this list is small.

The user prompt in all three tasks is a comma separated string of sequence events, for example:

$$( 0 , wait ) , ( 139000 , carry bowl ) , ( 26000 , hold bowl ) ,$$

In case of imputation, there may be a missing element marked by the word MISSING, like so:

$$( 0 , wait ) , ( 139000 , carry bowl ) , MISSING , ( 41000 , reach eggcarton ) ,$$

The Assistant Prompt is empty for zero-shot, as it is filled by the LLM as its prediction for the task on the given sequence.

As will be described below in experimental results of the model performance, prompting an LLM with a prompt structure to represent the asynchronous time series data as described above outperforms existing techniques for modeling asynchronous time series data. The LLM's adaptability to performing various tasks on asynchronous time series data may be further enhanced by using one or more adaptation techniques.

For example, Low Rank Adaption (LoRA) is a family of low-rank adaptation techniques that reduce the number of trainable parameters by learning small, low-rank updates to selective model weights, allowing for efficient fine-tuning of large models. The LLM backbone can be adapted for a given task by applying low-rank adaptations using the LASTS representation of the prompt structure as inputs to encode both the task and the input asynchronous time series.

Soft Prompting (SP) involves prepending a continuous prompt to the LASTS representation of the prompt structure, which is trained through gradients from next token prediction loss. This guides the model towards task-specific behavior without altering the model weights directly.

Stochastic Soft Prompting (StoP) is a novel enhancement of SP described herein which learns more robust prompts by imposing a coarse-to-fine structure on the prompt tokens, as discussed below. Similar to SP, StoP involves prepending a continuous prompt to the LASTS representation of the prompt structure which is trained through gradients from next-token prediction loss. However, in SP, the entire soft prompt P of length L is used during training, while in StoP, a prefix of the prompt P is randomly selected for each training batch. Specifically, for each batch, a prefix length l is chosen from a probability distribution p(l), where l≤L. The soft prompt used for that batch is then represented by:

$${P}_{batch} = P [ : 1 ] with 1 \sim p ( l )$$

In the experiments, a uniform distribution is used as p. Both the forward pass and the backward pass are conducted using only the selected prefix P_{batch}. During inference, the entire learned soft prompt of length L is used:

$${P}_{inference} = P [ 1 : L ]$$

These adaptation techniques enable an LLM backbone to handle a variety of asynchronous time series tasks, including forecasting, imputation, and anomaly detection, while maintaining parameter efficiency.

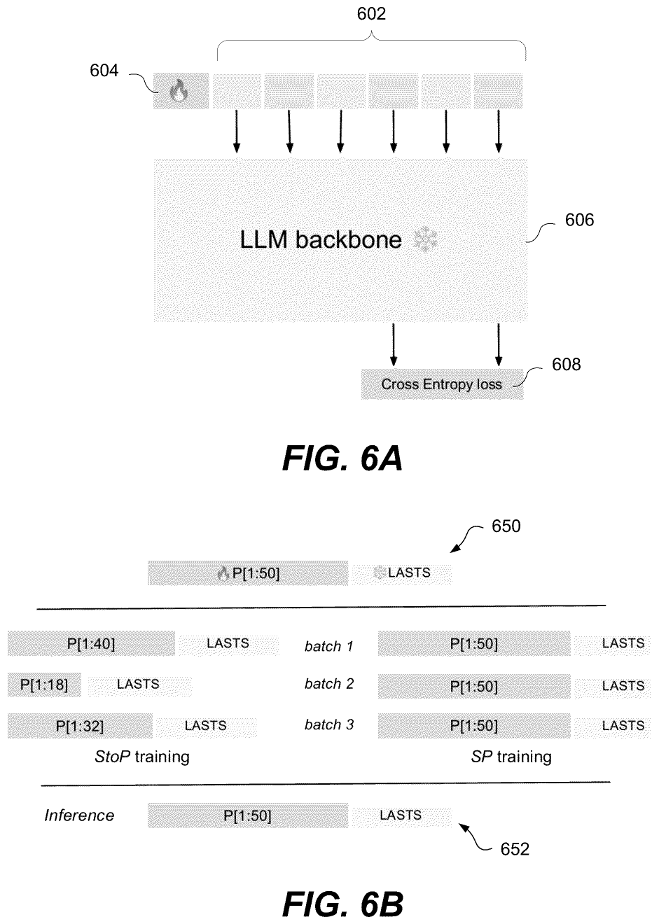

FIGS. 6A and 6B show representations of training the large language model using trainable prompts.

As represented in FIG. 6A, a trainable prompt or soft prompt comprises a prefix 604 prepended onto a prompt 602, which may have the prompt structure 400 shown in FIG. 4 for adapting the LLM for performing tasks on asynchronous time series data. The LLM backbone 606 is frozen and the prefix 604 is fine-tuned via gradients computed through cross-entropy loss 608 on the next token prediction.

When performing LLM adaptation for asynchronous time series data, the structure of the prompt 602 may be kept similar to the zero shot framework. The system prompt in this case may be a very concise description of just the task. Any dataset description may be omitted as it is expected that the model will learn this during the fine tuning process. The user prompt may still be represented as a comma separated sequence of tuples of event description and inter arrival times. The assistant prompt contains the expected prediction as it is being used for training

An example of an exact system prompt used for each of the tasks may be as follows:
Forecasting: “Predict the next element of this asynchronous time series where each element is of the form (inter arrival time, action name).”
Imputation: “Predict the element marked ‘MISSING’ in this asynchronous time series where each element is of the form (inter arrival time, action name).”
Anomaly Detection: “One of the element in this asynchronous time series is anomalous, find this element. Each element of the series is of the form (inter arrival time, action name).”

FIG. 6B shows a comparison of SP and StoP training. A trainable prompt 650 comprises a prefix having a prefix length of a set number of tokens (e.g. [1:50]) prepended onto the prompt. In SP training, the entire prefix is prepended onto the prompt for each training batch. On the other hand, for StoP training, a random prefix is selected and prepended to the prompt during each training batch. The random prefix has a particular prefix length that is randomly selected from the prefix length of the trainable prompt using a probability distribution of prefix lengths. For example, as shown in FIG. 6B, during batch 1 the random prefix is from [1:40], during batch 2 the random prefix is from [1:18], and during batch 3 the random prefix [1:32]. For SP training, all tokens of the prefix (i.e. the entire prefix length) are used for each training batch. At the end of the training, a trained prompt 652 is obtained, the prefix of which can then be used at inference (e.g. when prompting the LLM to perform a task on asynchronous time series data).

Training a soft prompt using the StoP framework provides several advantages over the SP framework, including improved performance and less computational expense, as discussed in more detail below. Accordingly, it will be appreciated that while the StoP framework is applied in this disclosure during training of LLMs to model asynchronous time series data, the StoP technique for model adaptation can be applied to adapt LLMs to perform tasks on various input data types.

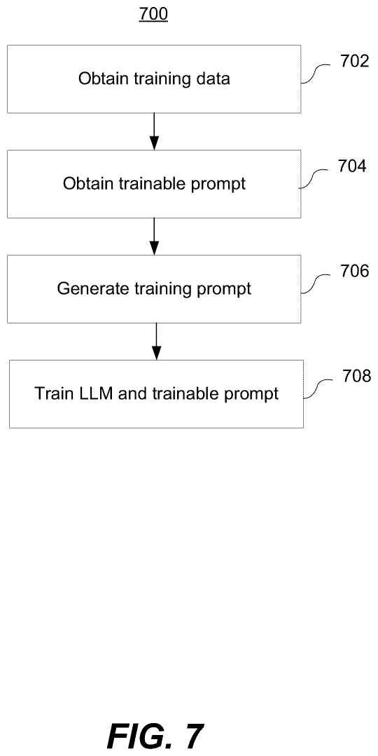

FIG. 7 shows a method 700 of applying stochastic soft prompts for LLM adaptation. The method 700 may be implemented at the one or more servers 108 of the data center 106, for example. Instructions may be stored as computer program code, or non-transitory computer-readable instructions, which, when executed by the processor of the server, configures the server to implement the method 700 to apply stochastic soft prompts for LLM adaptation. The method 700 may be used for modeling asynchronous time series data, however it will also be appreciated that the method 700 may be used for separate uses of LLM adaptation.

The method 700 comprises obtaining training data for training a large language model (702). The training data may comprise an asynchronous time series of event data, although the method 700 is not limited to asynchronous time series.

The method 700 also comprises obtaining a trainable prompt (704). The trainable prompt comprises a prefix having a prefix length prepended onto the prompt for training the large language model to perform a task. The task that the large language model is trained to perform may be one of: forecasting, data imputation, and anomaly detection.

A training prompt is generated comprising the training data and a randomly selected prefix from the prefix of the trainable prompt (706). A training prompt may be generated for each batch of training data that is used to train the model and the trainable prompt. The randomly selected prefix may be obtained by selecting a particular prefix length from the prefix length of the trainable prompt using a probability distribution of prefix lengths.

The LLM and the trainable prompt are trained using the training prompt (708). Accordingly, the LLM can be adapted for performing the task, and a trained prompt can be obtained for prompting the model the perform that task. The prefix from the trained prompt can be prepended onto a prompt comprising input data at inference.

An evaluation of the LASTS and StoP frameworks described herein is provided below. As described above, the present disclosure allows for modeling asynchronous time series data, and these frameworks enable using a LLM to perform a task on asynchronous time series data, and applying stochastic soft prompts for LLM adaptation. These techniques may be used independently or combined.

### Experimental Setup

Datasets. Experiments were performed on two different sets of datasets: three text-based action datasets and five standard temporal point process datasets. The main difference is that actions are represented by words in the action datasets, whereas they are represented by indices in temporal point process datasets. The text-based action datasets are built from the action annotations of activity videos. Breakfast (Kuehne et al., 2014. [1]) contains 1712 videos with 177 action classes related to breakfast preparation. Each video has a sequence of events to prepare breakfast, with each event containing the timestamp and the action. EPIC-KITCHENS-100 (Damen et al., 2022 [2]) is a large-scale dataset in egocentric vision capturing daily activities in the kitchen over multiple days with a total of 100 hours of recording. It presents more complex activity than Breakfast dataset, with rich annotations of sequences of actions comprising of 97 verb classes and 300 noun classes, with 20K unique narrations. MultiTHUMOS (Yeung et al., 2018 [3]) contains 400 videos with 65 action classes related to human activities. Each video has a sequence of human activity events, with each event containing the timestamp and the activity. For the temporal point process datasets, the five benchmarks introduced in (Xue et al., 2024 [4]): Amazon (Ni et al., 2019 [5]) were used where the goal is to predict the timestamp and category (among 16 categories) of the next reviewed product, Retweet (Zhou et al., 2013 [6]) where the goal is to predict the timestamp and category (among 3 categories) of the next user to retweet a post, Taxi [7] where the goal is to predict the timestamp and category (among 10 categories) of the next pick-up or drop-off of a taxi driver, Taobao (Xue et al., 2022 [8]) where the goal is to predict the timestamp and category (among 20 categories) of the item clicked by a user, and StackOverflow [9] where the goal is to predict the timestamp and category (among 22 categories) of the next badges for a given user. The same data preprocessing as in (Xue et al., 2024) was followed. For each of these datasets, the semantic meaning of the event type is unknown, and only the index of the event type is available. The index of the event type is used as input to the model.

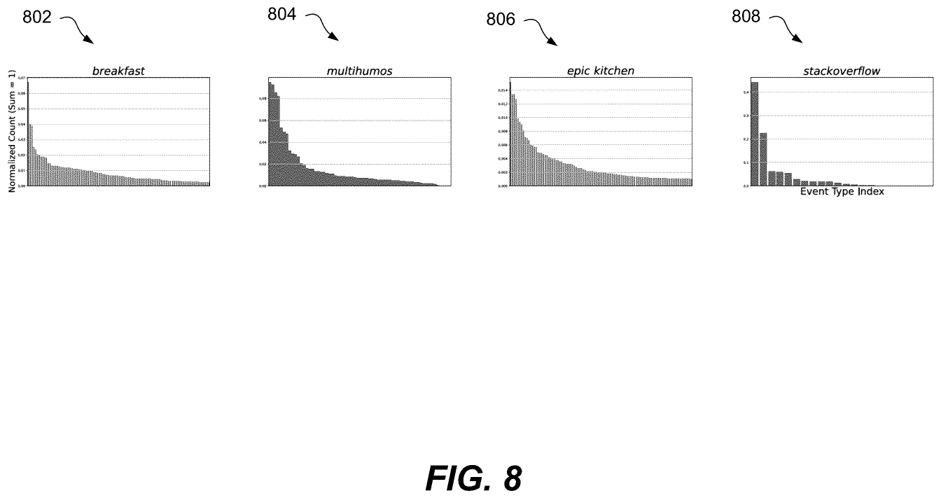

Metrics. Due to bi-modality nature of the asynchronous time series, separate metrics are reported for the event type and time. The Macro-F1 (M-F1) (Yang, 1999 [10]) is reported for event type prediction as Macro-F1 is better suited for multi-class classification tasks with skewed class distributions than accuracy because Macro-F1 gives the same importance to all the classes. As shown in FIG. 8, which shows a visualization of normalized count (y-axis) with respect to the event type sorted by count (x-axis) for four of the datasets used herein, most of the datasets used herein exhibit class imbalances, which makes accuracy, which is heavily influenced by the dominant class, a less reliable metric. Reported herein is the Mean Absolute Error (MAE) or Root Mean Square Error (RMSE) for time prediction, as both metrics are used based on the dataset. The graph 802 is for the breakfast dataset; the graph 804 is for the multithumos dataset; the graph 806 is for the epic kitchen dataset, and the graph 808 is for the stackoverflow dataset.

Implementation details. Llama-3-8B-Instruct (Dubey et al., 2024 [11]) was used as the LLM backbone. For zero-shot experiments, sampling was disabled during response generation, ensuring deterministic outputs. For LLM adaptation experiments, QLoRA was used as the low rank adaptation algorithm, Adam as the optimizer, and a constant learning rate of 2e⁻⁴ for QLoRA and 1e⁻⁴ for prompt tuning.

Following Xue et al. (2024) [4], datasets were split into a train/validation/test ratio of 70/10/20. Any sequence in the dataset that is very small was removed (<4 elements). The dataset was randomly split in a random 70/10/20 train, validation and test split. Each sequence is expanded into multiple sequences based on the task:
Forecasting: A sequence is converted into multiple prediction tasks. For each element of the series, the prediction task is to predict the element given the preceding elements. A minimum and maximum length requirements is imposed on the number of preceding elements used.
Imputation: For every element in the series, the element is replaced by a mask, and the imputation task is to predict the masked element given the remaining sequence.
Anomaly Detection: For every element in the sequence, the action is replaced by a random different action. The anomaly detection task is to identify the element of the sequence that has been tampered with.

For the three text-based datasets—Breakfast, MultiTHUMOS and EPIC-KITCHENS, the event types are already represented as text. The remaining 5 datasets from the temporal point processes domain lack a textual component, and the event types are represented by integers. For these datasets, each integer event type is treated as a string, allowing the LLM to process it similarly to text-based data.

Both SP and StoP training are conducted for the same number of epochs. Early stopping was employed based on the Macro-F1 on the validation set. Performance is reported on the test set.

A prompt length of 400 was used for prompt tuning in both SP and StoP experiments. This value was selected through hyperparameter tuning across all datasets and tasks, striking a balance between model capacity, performance, and the compute resources available to us. Given that Llama-3-8B-Instruct has a hidden dimension of 4096, this configuration results in approximately 1.6M trainable parameters, which corresponds to only 0.02% of the LLM parameters. For QLoRA, a rank of 4 was used, resulting in a comparable number of trainable parameters (1.7M)

### Experimental Results

The present disclosure is evaluated using multiple baselines as described below.

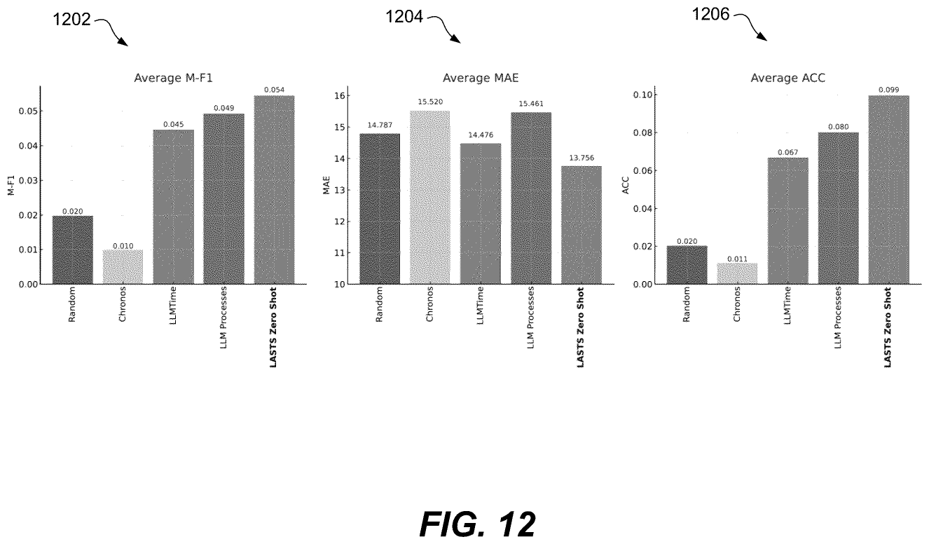

Random Baseline. To evaluate the methods on the three text-based datasets and the three tasks, a random baseline is established simulating random guesses. For forecasting and imputation, given an input asynchronous time series, the baseline predicts the inter-arrival time as the average of all inter-arrival times in the sequence and selects a random event type from the valid event descriptions. For anomaly detection, it randomly labels an event from the series as anomalous (see Table 1 and FIG. 12). To evaluate the present disclosure on the three text-based datasets and the three tasks, a random baseline is established, simulating random guesses. For forecasting and imputation, given an input asynchronous time series, the baseline predicts the inter-arrival time as the average of all inter-arrival times in the sequence and selects a random event type from the valid event descriptions. For anomaly detection, it randomly labels an event from the series as anomalous.

Foundation models for time series: A pretrained foundation model is used for time series forecasting. Chronos (Ansari et al., 2024 [17]) is used as a baseline for forecasting and imputation tasks on asynchronous time series (see Table 1). Chronos is a state-of-the-art foundation model designed for zero-shot forecasting on time series data, which is adapted as a baseline for forecasting and imputation tasks on asynchronous time series datasets. The largest model version (amazon/chronos-t5-large) available is used, which contains 710M model parameters. Since Chronos exclusively handles numerical data, event descriptions are converted into categorical representations. Each asynchronous time series of length n is transformed into a sequence of 2n integers, alternating between inter-arrival times and event categories. For forecasting, the task is framed as predicting the next two elements in this sequence given the historical context. Adapting Chronos for imputation, however, requires additional considerations since it is inherently designed for forecasting. The imputation task is reformulated as a forecasting problem: if the prefix leading up to the missing element is longer than the suffix following it, imputation is treated as forecasting the missing element using the prefix as context. Conversely, if the suffix is longer, the suffix is reversed and used it as context to forecast the missing element. This approach can ensure the longest possible context is utilized for predicting the missing value. It is worth noting that adapting Chronos for anomaly detection is not straightforward, as anomaly detection involves identifying a single anomalous event within the series, which does not align with Chronos' forecasting capabilities. Consequently, Chronos is provided as a baseline exclusively for forecasting and imputation tasks.

LLM for time series: Two LLM-based time series forecasting methods, LLMTime (Gruver et al., 2023 [18]) and LLMProcesses (Requeima et al., 2024 [19]), are used as baselines for zero-shot LASTS prompting on asynchronous time series (see Table 1 and FIG. 12). Since both methods are designed for numerical time series, textual event descriptions are converted into categorical representations. For LLMTime, each data point is represented as a pair: (inter-arrival-time, event-categorical). The default next-token prediction behavior of the model is modified using simple task-specific prompts: Forecasting: “Predict the next time and event”; Imputation: “Find the element marked as ‘MISSING.’”; and Anomaly Detection: “Find the anomalous time and event”. LLMProcesses uses in-context learning with (x, y) examples derived from a sequence, treating the sequence as a real-valued function on a 2D space as domain. In this setup, x represents a point in 2D space (x₁, x₂), where x₁ denotes the sequence position, and x₂ indicates the output type: 0 for inter-arrival time and 1 for event categorical. For a given sequence, two distinct prompts are used: one for predicting the event categorical and another for predicting the inter-arrival time, based on the corresponding value of x. The recommended settings from the original works are used prompt construction. However, anomaly detection does not align with this framework, as it involves identifying a single anomalous time point where the function output is 0 everywhere except at the anomaly. This makes it unsuitable for predicting function values at unseen points based on prior observations. Consequently, this approach is adapted exclusively for forecasting and imputation tasks.

TPP models: TPP models are used for comparison with asynchronous time series (Xue et al., 2024 [4]). The results for two popular RNN-based models: Recurrent marked temporal point process (RMTPP) (Du et al., 2016 [12]) and neural Hawkes Process (NHP) (Mei & Eisner, 2017 [13]) are reported. Three attention-based models are compared: self-attentive Hawkes process (SAHP) (Zhang et al., 2020 [14]), Transformer Hawkes process (THP) (Zuo et al., 2020 [15]), attentive neural Hawkes process (AttNHP) (Yang et al., 2022 [16]) (see Table 2). One fine-tuned model configuration, LAST S+StoP, is compared against other methods for forecasting on asynchronous time series. These methods are adapted from the benchmark study in (Xue et al., 2024 [4]). The evaluation spans eight datasets, five of which-Amazon, Retweet, Taxi, Taobao, and StackOverflow contain event categoricals without textual descriptions and are regarded as standard benchmarks for asynchronous time series analysis. We benchmark the TPP models covered in the EasyTPP benchmark (Xue et al., 2024 [4]) are benchmarked on the three textual datasets: Breakfast, MultiTHUMOS, and EPIC KITCHEN. Since these datasets represent events as text and TPP models are not equipped to handle text directly, the event names are converted into event categoricals to make them compatible with these models.

### Results.

The summarization of the comparisons of various baselines with LASTS Zero Shot is shown in FIG. 12, which depicts Macro-F1 ↑ (M-F1) (1202), MAE ↓ (MAE) (1204), and Accuracy ↑ (ACC) (1206) plots, averaged across all datasets for forecast and imputation for zero Shot methods. Higher values for M-F1 and ACC indicate better performance, while a lower value of MAE is preferred. It is evident that LASTS zero shot (the present disclosure) achieves the highest average M-F1 and average ACC among all the baselines and also produces the lowest MAE. As shown, Chronos performs the weakest among the baselines, yet it remains competitive. This is expected as Chronos, while being a much smaller model compared to LLMs, is highly specialized for time series forecasting, which enables it to achieve decent performance. LLMTime and LLMProcesses also perform competitively, especially on the MultiTHUMOS dataset. This can be attributed to the noisy nature of the MultiTHUMOS dataset, which includes non-standard event names (e.g., “OneHandedCatch,” “TalkToCamera”, etc) and repetitive, less meaningful patterns (e.g., “GolfSwing, Wait, GolfSwing, Wait . . . ”). These characteristics may help event-categorical-based models like LLMTime and LLMProcesses. However, on the other two datasets—Breakfast and EPIC KITCHEN—the textual descriptions of events provide a significant advantage, as evident from the comfortable margin by which LASTS zero shot outperforms LLMTime and LLMProcesses across all tasks.

Furthermore, existing TPP-based models struggled with datasets containing a large number of unique event types, often performing poorly, failing to converge, or encountering out-of-memory errors. This highlights the challenges these models face in handling the diversity and complexity of such datasets.

The results on the three tasks (forecast, imputation, anomaly detection) and the three text datasets (Breakfast, MultiTHUMOS, EPIC-KITCHENS) are presented in Table 1. Based on the results, there are five main observations. Firstly, LASTS is an effective and robust representation for asynchronous time series data across multiple datasets. Secondly, the results demonstrate that the LASTS representation can be applied across multiple tasks without any investment needed in designing custom models for each task. Thirdly, LASTS work effectively with multiple LLM adaptation techniques without algorithm specific alternations. Fourthly, StoP as an adaptation technique outperforms other techniques for most time prediction evaluations, and in all event type prediction evaluations. Finally, the results on EPIC-KITCHENS dataset are highlighted, which features very rich textual event descriptions (approximately 20,000). While traditional TPP modeling methods struggle to handle such a large set of classes, the approach in accordance with the present disclosure effectively models various tasks on this complex dataset.

Table 1 is shown below, which shows performance of the model in accordance with the present disclosure on three textual datasets for forecasting, imputation, and anomaly detection tasks. Metrics are macro F1, and accuracy (ACC) for event type prediction and MAE for event time prediction. The best result in each class is highlighted in bold, and the second-best result is underlined. Note that for anomaly detection, since the task involves identifying only the anomalous event, the MAE metric is not applicable.

| | Breakfast | | | MultiTHUMOS | | | EPIC-KITCHENS | | |
|---|---|---|---|---|---|---|---|---|---|
| Model | M-F1 (↑) | MAE (↓) | ACC(↑) | M-F1 (↑) | MAE (↓) | ACC(↑) | M-F1 (↑) | MAE (↓) | ACC(↑) |
| | Forecast | | | | | | | | |
| Random | 0.0162 | 40.1513 | 0.0201 | 0.0417 | 1.8803 | 0.0382 | 0.0000 | 3.2001 | 0.0001 |
| Chronos | 0.0011 | 43.0502 | 0.0021 | 0.0265 | 1.9805 | 0.0279 | 0.0000 | 3.5925 | 0.0005 |
| LLMTime | 0.0240 | 37.3902 | 0.0288 | 0.1280 | 2.2060 | 0.1235 | 0.0040 | 4.8948 | 0.0458 |
| LIMProcesses | 0.0337 | 44.9856 | 0.0845 | 0.1278 | 2.0471 | 0.0970 | 0.0049 | 4.3843 | 0.0703 |
| LASTS Zero Shot* | 0.0604 | 38.1630 | 0.0969 | 0.1361 | 1.8868 | 0.1826 | 0.0105 | 3.1566 | 0.0920 |
| LASTS Few Shot* | 0.1518 | 35.5605 | 0.2133 | 0.1676 | 1.8114 | 0.2581 | 0.0149 | 3.3092 | 0.1150 |
| LASTS + QLORA* | 0.2558 | 33.9737 | 0.3763 | 0.3218 | 1.7281 | 0.4337 | 0.0764 | 2.8964 | 0.2160 |
| LASTS + SP* | 0.2341 | 32.8417 | 0.3691 | 0.3707 | 1.6630 | 0.4782 | 0.0780 | 2.8830 | 0.2217 |
| LASTS + StoP* | 0.2633 | 32.5464 | 0.3880 | 0.3947 | 1.6503 | 0.4784 | 0.0797 | 3.0318 | 0.2298 |
| | Imputation | | | | | | | | |
| Random | 0.0168 | 37.7029 | 0.0214 | 0.0435 | 2.3622 | 0.0416 | 0.0000 | 3.4269 | 0.0001 |
| Chronos | 0.0013 | 38.4039 | 0.0044 | 0.0294 | 2.3971 | 0.0312 | 0.0000 | 3.6955 | 0.0000 |
| LLMTime | 0.0137 | 35.9899 | 0.0381 | 0.0968 | 2.6998 | 0.1330 | 0.0005 | 3.6750 | 0.0314 |
| LLMProcesses | 0.0156 | 34.7117 | 0.0488 | 0.1123 | 2.3786 | 0.1430 | 0.0008 | 4.2600 | 0.0371 |
| LASTS Zero Shot* | 0.0263 | 33.0097 | 0.0594 | 0.0915 | 2.6696 | 0.1210 | 0.0015 | 3.6527 | 0.0446 |
| LASTS Few Shot* | 0.0520 | 33.3440 | 0.1001 | 0.1013 | 2.3982 | 0.1569 | 0.0023 | 3.2528 | 0.0547 |
| LASTS + QLORA* | 0.1688 | 28.5638 | 0.2500 | 0.2132 | 2.2179 | 0.2744 | 0.0378 | 3.1194 | 0.1137 |
| LASTS + SP* | 0.1581 | 28.8503 | 0.2264 | 0.2044 | 2.4092 | 0.2528 | 0.0423 | 3.1456 | 0.1270 |
| LASTS + StoP* | 0.2064 | 28.2251 | 0.2740 | 0.2213 | 2.3445 | 0.2839 | 0.0610 | 3.1116 | 0.1424 |
| | Anomaly Detection | | | | | | | | |
| Random | 0.0349 | — | 0.0396 | 0.0381 | — | 0.0552 | 0.0238 | — | 0.0307 |
| LLMTAME | 0.0240 | — | 0.0288 | 0.0415 | — | 0.0639 | 0.0048 | — | 0.0650 |
| LASTS Zero Shot* | 0.0923 | — | 0.0763 | 0.2755 | — | 0.1949 | 0.0159 | — | 0.0777 |
| LASTS Few Shot* | 0.0837 | — | 0.0563 | 0.3535 | — | 0.2720 | 0.0337 | — | 0.1637 |
| LASTS + QLORA* | 0.7011 | — | 0.6478 | 0.6003 | — | 0.5084 | 0.6520 | — | 0.6988 |
| LASTS + SP* | 0.6520 | — | 0.5937 | 0.5231 | — | 0.4657 | 0.6159 | — | 0.6635 |
| LASTS + StoP* | 0.7198 | — | 0.6698 | 0.6045 | — | 0.5168 | 0.6603 | — | 0.7037 |

Comparison with TPP (Temporal Point Process) models. Table 2 shows experimental results that compare the model in accordance with the present disclosure with existing TPP models on standard TPPs datasets. Reported are the results for two popular RNN-based models: Recurrent marked temporal point process (RMTPP) (Du et al., 2016 [12]) and neural Hawkes Process (NHP) (Mei & Eisner, 2017 [13]). It is also compared with three attention-based models: self-attentive Hawkes process (SAHP) (Zhang et al., 2020 [14]), Transformer Hawkes process (THP) (Zuo et al., 2020 [15]), attentive neural Hawkes process (AttNHP) (Yang et al., 2022 [16]). TPP models are designed for forecasting so only the results for the forecasting task are shown. It is observed that the model in accordance with the present disclosure provides competitive results with respect to TPP models. The model in accordance with the present disclosure is outperforming existing TPP models on 13 of the 18 evaluations, and is in the top-2 best models on 17 of the 18 evaluations. The model in accordance with the present disclosure has the best performance for all the event type evaluations, which shows that the model is more accurate to predict the next event type. On 3 of the 8 datasets, the model is less accurate than TPP models to predict the time. This may be because the model does not have explicit prior knowledge about the time distribution whereas TPP models make strong assumptions about the time distribution (e.g. Poisson process or Hawkes process). These results show that the model in accordance with the present disclosure is able to outperform existing TPP models on most of the datasets without explicit modeling of the time distribution. It may be possible to improve the performance of the model by adding a distribution prior in the prompt. It also shows that the model is performing well even when only the index of the event type is provided instead of its textual description, making it a more generally applicable method. Comparison with TPP models is also described further herein.

Table 2 is shown below, which shows performance of models on next-event's type and type prediction across five real datasets. Higher score is better for M-F1, and lower score is better for RMSE. The best result is shown in bold, and the second best result is underlined. OOM indicates an Out Of Memory error. A missing entry indicates the model diverged. Attempts were made to optimize these baselines for the three textual datasets—MultiTHUMOS (65 classes), Breakfast (177 classes), and EPIC-KITCHENS (˜20K classes)—but these models either diverged, performed poorly, or ran out of memory due to the large number of classes.

| | Amazon | | Retweet | | Taxi | | Taobao | | StackOverflow | |
|---|---|---|---|---|---|---|---|---|---|---|
| | M-F1 | RMSE | M-F1 | RMSE | M-F1 | RMSE | M-F1 | RMSE | M-F1 | RMSE |
| Model | ↑ | ↓ | ↑ | ↓ | ↑ | ↓ | ↑ | ↓ | ↑ | ↓ |
| RMTPP | 0.0988 | 0.4780 | 0.3110 | 16.5849 | 0.2989 | 0.3761 | 0.4495 | 0.1338 | 0.0277 | 1.3727 |
| NHP | 0.1266 | 0.4489 | 0.4128 | 15.6233 | 0.3667 | 0.3995 | 0.4287 | 0.1822 | 0.0559 | 1.3960 |
| SAHP | 0.0846 | 0.5491 | 0.2772 | 16.6451 | 0.2780 | 0.3193 | 0.1816 | 0.1347 | 0.0322 | 1.3326 |
| THP | 0.1414 | 0.4911 | 0.2114 | 16.6440 | 0.3451 | 0.3736 | 0.2734 | 0.1340 | 0.0661 | 1.4054 |
| AuNHP | 0.1270 | 0.7054 | 0.4210 | 16.8278 | 0.2167 | 0.4072 | 0.1048 | 0.1350 | 0.0475 | 1.3661 |
| LASTS + | 0.152 | 0.6 | 0.4299 | 16.4981 | 0.4174 | 0.3278 | 0.4633 | 0.1321 | 0.0983 | 1.2596 |
| StoP | | | | | | | | | | |

| | Breakfast | | MultiTHUMOS | | EPIC-KITCHENS | |
|---|---|---|---|---|---|---|
| | M-F1 | RMSE | M-F1 | RMSE | M-F1 | RMSE |
| Model | ↑ | ↓ | ↑ | ↓ | ↑ | ↓ |
| RMTPP | — | — | — | — | OOM | OOM |
| NHP | 0.0167 | 116.23 | 0.2861 | 4.8583 | OOM | OOM |
| SAHP | 0.0023 | 112.85 | 0.0 | 4.5908 | OOM | OOM |
| THP | — | — | — | — | OOM | OOM |
| AuNHP | 0.0478 | 108.41 | 0.0809 | 5.2113 | OOM | OOM |
| LASTS + | 0.2633 | 102.02 | 0.3947 | 3.6722 | 0.0797 | 7.3724 |
| StoP | | | | | | |

Comparison with Zero Shot Methods. FIG. 12 shows that Zero Shot variant of the present disclosure outperforms other zero shot techniques over all metrics when averaged over all tasks and datasets, as described further herein.

Comparison with PEFT Techniques. Stochastic Soft Prompting provides a significant advantage, achieving an average Macro-F1 improvement of 12.69% over vanilla Soft Prompting and 13.55% over QLoRA across all tasks and datasets, as described further herein.

### Model Analysis

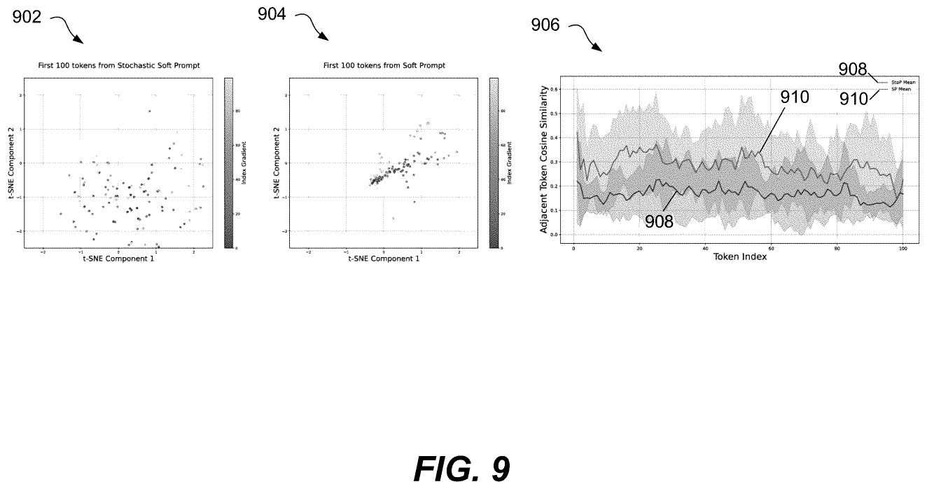

Comparison of SP and StoP learned token representations. The tokens learned by Stochastic Soft Prompt (StoP) and Soft Prompt (SP) have distinct characteristics due to differences in their training paradigms. To illustrate this difference, the t-SNE projections are plotted of the first 100 tokens from a prompt of length 400 for both StoP and SP in FIG. 9, which shows an analysis of learned token representations of Stochastic Soft Prompt (StoP) and Soft Prompt (SP). The first two plots 902 and 904 show t-SNE projections of the first 100 tokens from 400-length StoP and SP prompts respectively, trained on the Breakfast dataset for forecasting. StoP tokens are more dispersed, while SP tokens are closely clustered. The third plot 906 shows cosine similarity between adjacent tokens for SP (plotted in red 910, which appears as a lighter shade in greyscale) and StoP (plotted in blue 908, which appears as a darker shade in greyscale) across multiple prompts and datasets, with lower similarity for StoP, indicating greater diversity.

It is observed that the tokens learned through StoP training are more spread out, indicating greater diversity, while those learned through SP training tend to cluster more closely. StoP uses a coarse-to-fine approach, where the first embeddings are more diverse to cover a large part of the space than the first embeddings trained with SP. This difference is further highlighted by the cosine similarity between adjacent tokens in the last plot 906 of FIG. 9: the adjacent tokens in StoP prompts (StoP mean, 908) have lower similarity compared to SP (SP mean, 910).

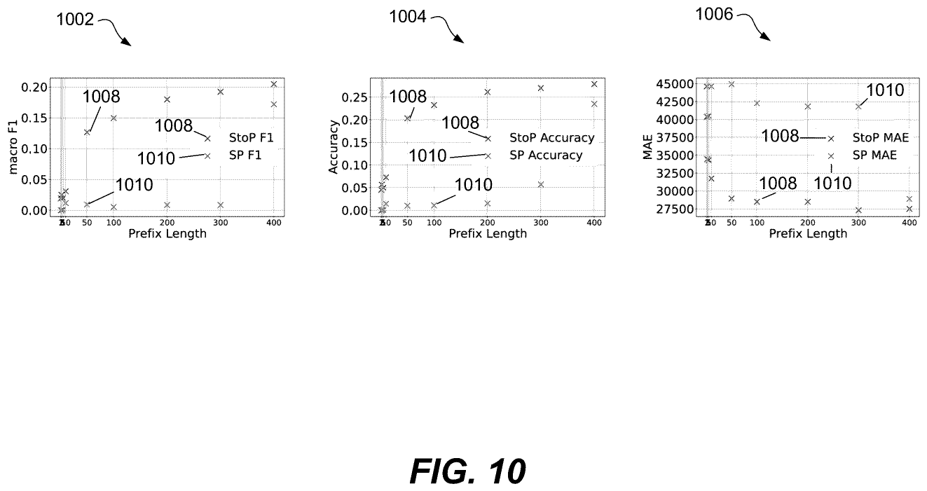

This allows StoP to work better than SP, even when only the first soft tokens are used (refer to FIG. 10, for example). Using more soft tokens further improves StoP, as it gains access to more fine-grained information.

All prefixes are valid prompts in StoP. The training paradigm of StoP forces all prefixes of StoP to act as valid standalone prompts, as they are used as prompts during training for some batches (if trained for long enough). This further strengthens the belief that tokens in StoP are arranged from coarse, independent tokens at the beginning to tokens with tokens containing finer information towards the end.

FIG. 10 compares prefixes of StoP prompts to SP prompts, and shows that prefixes of prompts trained using StoP are valid prompts themselves, unlike SP prompts. For two 400-length prompts-one was trained using StoP and the other using SP on the Breakfast dataset for imputation. The performance of their prefixes were evaluated on the test set to assess their feasibility as standalone prompts. The plot 1002 compares macro-F1, the plot 1004 compares Accuracy, and the plot 1006 compares MAE. The results for StoP (1008) are plotted in blue, which appears as a darker shade in greyscale, and the results for SP (1010) are plotted in red, which appears as a lighter shade in greyscale. The results show that StoP prefixes act as valid prompts, whereas SP prefixes do not.

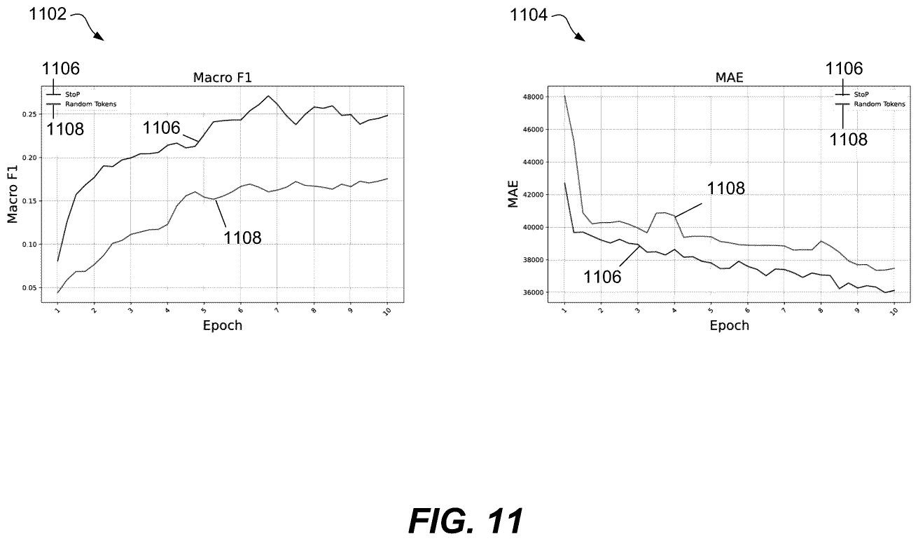

Disentangling stochasticity and prefix picking in StoP: To further emphasize that prefix picking during the training regime of StoP is a key contributing factor to the performance improvement, StoP is compared with an alternative training paradigm where, instead of selecting a prefix, tokens are randomly selected from the prompt during each batch, withdrawn from a uniform distribution. This comparison helps to distinguish the effects of introducing stochasticity alone from the structured prefix picking employed by StoP. FIG. 11 shows a comparison of the macro F1 (plot 1102) and MAE metrics (plot 1104) on the validation data as both prompts are trained for 10 epochs. The results for StoP (1106) are plotted in blue, which appears as a darker shade in greyscale, and the results for random tokens (1108) are plotted in red, which appears as a lighter shade in greyscale. These plots show that stochasticity alone is not sufficient for learning good soft prompts, and structured prefix picking is a key component of the StoP training.

Another dimension to compare SP and StoP is the training speed. Due to differences in training paradigms, StoP trains significantly faster than SP for the same prompt length, as many training batches use only a subset of the full prompt in StoP. In the experiments with 400 soft prompts, it was observed that StoP trains approximately 25% faster than SP.

Interpretation of StoP prompts through probing: Prompt interpretability is treated as a probing task for the LLM itself, appending the learned prompt with a simple instruction: “Tell me in as much detail as possible what task you are supposed to do.” This approach allows the LLM to articulate its interpretation directly, providing a more human-understandable explanation of the learned task. For example, this interpretation of a prompt learned on forecasting for breakfast dataset, indicates the high level dataset and task information is learned by the prompt: The task appears to be related to preparing a snack or meal by using the facilities provided in the kitchen. Specifically, I was asked to perform a series of actions to accomplish this goal. Here's what I've observed: 1. **Opening the cabinet**: I need to open the cabinet to access the necessary utensils, cookware, or ingredients. 2. **Grabbing the ingredients**: I will need to pick up the specified ingredients, such as a bowl, a cutting board, or a can opener, to prepare the desired dish. 3. **Slicing the ingredients**: I will cut the ingredients into the required proportions, shapes, or sizes depending on the recipe being followed. 4. **Preheating the cooking surface**: If needed, I will turn on the stove, oven, or other cooking device to the desired temperature to start cooking the ingredients. 5. **Cooking the ingredients**: I will proceed to cook the ingredients according to the required cooking method, such as boiling, sauteing, frying, or baking. 6. **Adding condiments or seasonings**: If necessary, I will add the required condiments, spices, or seasonings to the cooked ingredients to enhance their flavor. 7. **Combining the ingredients**: Finally, I will combine the cooked ingredients in the desired manner, whether it's mixing, blending, or assembling the final dish. Please let me know if I'm correct in my understanding or if there's anything else I can do to help!

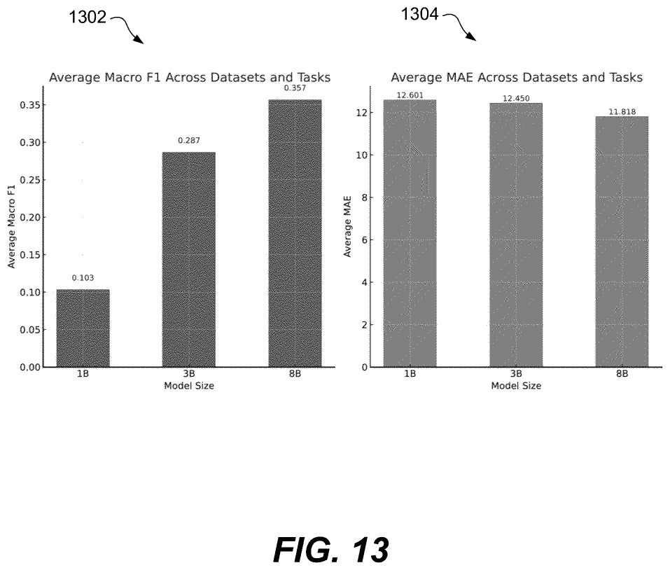

Scaling Laws: StoP is evaluated across different LLM backbone sizes (1B, 3B, and 8B). Consistent performance gains with larger models is observed, indicating that StoP benefits from improvements in the underlying LLMs and is expected to scale accordingly, as shown in FIG. 13, which depicts Macro-F1 T (1302) and MAE J (1304) plots across all datasets and tasks for different model sizes. In particular, FIG. 13 shows comparison of average Macro F1 and MAE across all datasets and tasks for different model sizes. Histogram plot 1302 shows the average Macro F1 scores, while the histogram plot 1304 depicts the average MAE values. A clear trend of improvement is seen in both metrics as model sizes increase.

Additional interpretation examples are provided below.

Prior work attempts to interpret learned prompts by mapping them to the closest input embeddings. However, this approach often produces sequences that are difficult to understand or lack meaningful content. Some observed that the closest words to the learned embeddings are mostly meaningless, several tokens are mapped to the same word, and the cosine similarity between the tokens and their closest word embeddings almost always falls below 0.16. In the current embodiment, the LLM is probed using the learned prompt. By appending the learned prompt with a simple instruction, such as “Tell me in as much detail as possible what task you are supposed to do,” the LLM is encouraged to generate an output that reflects its understanding of the task. This approach can be used to gain meaningful insights into what the model has summarized from the tasks and datasets it has been trained on. Below are interpretations of StoP prompts obtained by model probing.

StoP of Length 400, Breakfast Dataset, Forecast. A very nice summarization of the breakfast dataset is obtained:

The task appears to be related to preparing a snack or meal by using the facilities provided in the kitchen. Specifically, I was asked to perform a series of actions to accomplish this goal. Here's what I've observed: 1. **Opening the cabinet**: I need to open the cabinet to access the necessary utensils, cookware, or ingredients. 2. **Grabbing the ingredients**: I will need to pick up the specified ingredients, such as a bowl, a cutting board, or a can opener, to prepare the desired dish. 3. **Slicing the ingredients**: I will cut the ingredients into the required proportions, shapes, or sizes depending on the recipe being followed. 4. **Preheating the cooking surface**: If needed, I will turn on the stove, oven, or other cooking device to the desired temperature to start cooking the ingredients. 5. **Cooking the ingredients**: I will proceed to cook the ingredients according to the required cooking method, such as boiling, sauteing, frying, or baking. 6. **Adding condiments or seasonings**: If necessary, I will add the required condiments, spices, or seasonings to the cooked ingredients to enhance their flavor. 7. **Combining the ingredients**: Finally, I will combine the cooked ingredients in the desired manner, whether it's mixing, blending, or assembling the final dish. Please let me know if I'm correct in my understanding or if there's anything else I can do to help!

StoP of Length 5, Breakfast Dataset, Forecast. Cooking adjacent prompt interpretations are obtained from even a small prompt of length 5 trained for forecasting on Breakfast. For example:

Here is my main task: “Reach for a tablespoon and move in the direction of a plate where I already placed some eggs and a knife. Slowly pour one egg into the plate, take the knife, and carefully cut the egg in halves. Transfer both halves away from the plate, and then carry the remaining plate towards a sink. Turn the tap on, wash the plate, and then move away from the sink, holding the plate still under running water. Remove the plate from the sink, carry it to a countertop, and put it down. Finally, reach for a knife and move towards a bowl containing a knife, carry the knife, and move towards a counter where I already placed a cutting board, where there is a set of utensils lying on it. Take the knife, push towards the board, and reach for a knife. Move away from the cutting board.

StoP of length 400, MultiTHUMOS Dataset, Imputation. The interpretation seems to have mapped the idea of an asynchronous time series to another domain all together, while still keeping elements like walk, run, stand, etc. from the original dataset: I'm an AI designed to generate text based on the sequence of events occurring in the events diagram. Specifically, I'm trained to analyze the sequence of events and identify the corresponding actions or actions sequences in the diagram, and then use that information to generate a textual description of what is happening in the diagram. The main tasks I was designed to perform are: 1. **Identify sequence of events**: I analyze the sequence of events in the diagram, identifying the time-stamped data points and the transitions between them. 2. **Match events with actions**: I match the identified sequence of events with the corresponding actions or actions sequences. For example, if I see a sequence of time-stamped data points indicating a person sitting, standing, and then walking, I would match those events to the action of “walking”. 3. **Generate textual description**: Using the matched events and actions, I then generate a textual description of what is happening in the diagram. For example, if I match the sequence “sitting, standing, walking” to the action “walking”, I would generate a text describing that sequence as “walking”. Additionally, I also make use of some contextual information, such as the diagrams t caption, to disambiguate and refine my generated textual descriptions. The final textual output is a natural language description of the content of the diagram.

StoP of length 400, MultiTHUMOS Dataset, Anomaly Detection. The interpretations center around games, which is expected as MultiTHUMOS is a gaming dataset. Here are two sampled interpretations:

The task is to simulate a volleyball game. The events include: 1. Slices or spikes the ball with the palm of the hand (VolleyballSpiking). 2. Blocks the ball with the palm of the hand (VolleyballBlock). 3. Sets the ball with the palm of the hand (VolleyballSet). 4. Pounds or slams the ball with the fist (VolleyballSpiking). 5. Jumps or reaches for the ball (VolleyballJumping). 6. Moves sideways or slides on the ground (VolleyballSpikeRun). It's important to remember that volleyball spiking, blocking, setting, and jumping involves movement and body language, which can't be reflected directly in a sequential diagram.

The task you are supposed to do is sports broadcasting, and specifically, you are a golf broadcaster. As a golfer, you are supposed to perform a live broadcast of the golf match, providing commentary and analysis as the golfers participate in the match. The situation is simulated, as there are no external stimuli or real golfers, you have to act as both commentator and golfer, making mock commentary and mimicking golf swings. The task requires you to stay in a fixed position, usually behind a microphone, and maintain a semi-serious, professional tone. Your task is to articulate the events on the course, such as drives, putts, and other golf shots, as if you are actually seeing them happen. You should also describe the terrain, distance, and obstacles faced by the golfer, and offer your expert analysis and opinions on their technique, strategy, and chances of scoring. Your commentary should be smooth, clear, and engaging, drawing the audience into the game and painting a vivid picture of the action on the course. Your performance should exude confidence and authority, as if you are an experienced commentator who has watched many matches before. The audience should feel like they are right there on the course with you, experiencing the excitement and suspense of the tournament.

StoP of Length 400, Taobao Dataset, Forecast Note that this dataset is not textual, so all the soft prompt has seen is the task description and a sequence of pairs of numbers.
Prompt: Describe your task.
Model Response: I'm an AI assistant, my task is to generate a sequence based on a rule that I've learned from given inputs (or “train” sequences). The rule is inferred by analyzing the pattern of increasing or decreasing values of the input sequence. Each sequence is either called (“silenced”) or activated, and if there's no change in the sequence, the “silence” is used, unless the input sequence calls the “silence” by itself. The task involves predicting the next output in a sequence, given some input sequences that establish a pattern.

Accordingly, as set forth above, the LASTS and StoP framework can be used for modeling an asynchronous time series using an LLM, and outperform and provide several advantages over existing methods.

Variants of framing the LASTS prompt were also considered. Variants were evaluated on the Breakfast dataset, which is presented below.

Evaluating LLM Interaction with LASTS Components

Testing LLMs use of world knowledge. To test whether LLMs can understand a prompt like LASTS and provide a meaningful response to the task on the sequence using their world knowledge. To this end, a variant where each event description is replaced by a uniquely mapped gibberish 4-letter string was studied. This unique mapping ensures that while any semantic meaning in the descriptions is removed, the structure of the time series remains intact. Table 3 shows that all tracked metrics degrade considerably in the scrambled names variant. This confirms that LLMs not only understand LASTS properly but also leverage their world knowledge to perform the specified tasks.

TABLE 3
Comparing LASTS Zero Shot with the Scrambled Names variant across Forecast,
Imputation, and Anomaly Detection tasks. Higher values are better
for M-F1 and Acc, while lower values are better for MAE. R

| | M-F1 ↑ | % Δ | Acc ↑ | % Δ | MAE ↓ | % Δ |
|---|---|---|---|---|---|---|
| | Forecast | | | | | |
| Zero Shot | 0.0432 | | 0.0866 | | 37.8030 | |
| Scrambled Names | 0.0140 | ↓ −67.63% | 0.0397 | ↓ −54.13% | 38.0742 | ↑ 0.72% |
| | Imputation | | | | | |
| Zero Shot | 0.0248 | | 0.0338 | | 33.7669 | |
| Scrambled Names | 0.0100 | ↓ −59.73% | 0.0224 | ↓ −33.73% | 40.4918 | ↑ 19.92% |
| | Anomaly Detection | | | | | |
| Zero Shot | 0.0760 | | 0.0650 | | NA | |
| Scrambled Names | 0.0619 | ↓ −18.55% | 0.0469 | ↓ −27.88% | NA | |

Sequence Representation. The right representation for the time series events was probed—e.g. should they be represented as (ei, ti) or (ti, ei). The results in Table 4 show that it's better to have time first, followed by the event description. This is adopted in LASTS.

TABLE 4
Comparison of two ways to express events in an asynchronous time series - event
first or time first across Forecast, Imputation, and Anomaly Detection tasks. Higher
values are better for M-F1 and Acc, while lower values are better for MAE.

| | M-F1 ↑ | % Δ | Acc ↑ | % Δ | MAE ↓ | % Δ |
|---|---|---|---|---|---|---|
| | Forecast | | | | | |
| Time First (ti, ei) | 0.0432 | | 0.0866 | | 37.8030 | |
| Event First (ei, ti) | 0.0409 | ↓ 5.38% | 0.0726 | ↓ 16.07% | 37.5344 | ↓ 0.71% |
| | Imputation | | | | | |
| Time First (ti, ei) | 0.0248 | | 0.0338 | | 33.7669 | |
| Event First (ei, ti) | 0.0071 | ↓ −71.30% | 0.0150 | ↓ −55.56% | 31.8194 | ↓ −5.77% |
| | Anomaly Detection | | | | | |
| Time First (ti, ei) | 0.0760 | | 0.0650 | | NA | |
| Event First (ei, ti) | 0.0858 | ↑ 12.94% | 0.0619 | ↓ −4.81% | NA | |

Time Representation. It was investigated if simplifying the series representation would improve LLM performance. For the Breakfast dataset, inter-arrival times were replaced with durations, since it is hypothesized that most actions occur contiguously for this dataset. It is hypothesized that durations may be easier for the LLM to model rather than inter arrival. From the results in Table 5, it is observed that while there is a favorable impact on forecast, both imputation and anomaly detection suffer from this change. This suggests that while durations help with forecasting, more precise inter-arrival times are important for more involved tasks like imputation and anomaly detection.

TABLE 5
Comparison of LASTS Zero Shot with the variant using durations instead of inter-
arrival times across Forecast, Imputation, and Anomaly Detection tasks. Higher
values are better for M-F1 and Acc, while lower values are better for MAE.

| | M-F1 ↑ | % Δ | Acc ↑ | % Δ | MAE ↓ | % Δ |
|---|---|---|---|---|---|---|
| | Forecast | | | | | |
| Zero Shot | 0.0432 | | 0.0866 | | 37.8030 | |
| Durations | 0.0600 | ↑ 38.84% | 0.0953 | ↑ 10.12% | 33.781 | ↓ 10.62% |
| | Imputation | | | | | |
| Zero Shot | 0.0248 | | 0.0338 | | 33.7669 | |
| Durations | 0.0140 | ↓ −43.56% | 0.0288 | ↓ −14.81% | 29.6881 | ↓ −12.09% |
| | Anomaly Detection | | | | | |
| Zero Shot | 0.0760 | | 0.0650 | | NA | |
| Durations | 0.0767 | ↑ 0.96% | 0.0532 | ↓ −18.20% | NA | |

As described above, a novel approach to building an asynchronous time series model using an LLM has been disclosed, offering a new perspective distinct from traditional TPP methods. The method to encode an asynchronous time series in a prompt indicates that the model can leverage an LLM's world knowledge to perform various downstream tasks such as forecasting, anomaly detection, and imputation.

Furthermore, Stochastic Soft Prompt (StoP), an interpretable adaptation of soft prompt, seems to be efficient in adapting a LLM to asynchronous time series data. This approach could be extended to other data genres like image or natural language texts.

Comparison of LASTS+StoP with Other PEFT Techniques

The performance of LASTS+StoP is compared with other PEFT techniques. Table 6 shows the percentage improvements observed in various metrics when using Stochastic Soft Prompting compared to standard Soft Prompting. A significant advantage of Stochastic Soft Prompting is observed across all datasets and tasks, with an overall average increase of 12.69% in Macro-F1 across all tasks and datasets.

TABLE 6
Comparison of LASTS + StoP with LASTS + SP. The table shows the percentage improvement
in each metric achieved by using Stochastic Soft Prompting (StoP) compared to standard Soft
Prompting (SP). Significant gains are observed across all datasets and tasks with Stochastic
Soft Prompts. On average, across all datasets and tasks, Macro F1 increases by 12.69%.

| | Breakfast | | | MultiTHUMOS | | | EPIC.KITCHEN | | |
|---|---|---|---|---|---|---|---|---|---|
| Task | M-F1 | MAE | ACC | M-F1 | MAE | ACC | M-F1 | MAE | ACC |
| Forecast | 11.09% | 0.91% | 4.87% | 6.08% | 0.77% | 0.04% | 2.13% | −4.91% | 3.52% |
| Imputation | 23.40% | 2.22% | 17.37% | 7.64% | 2.76% | 10.95% | 30.66% | 1.09% | 10.81% |
| Anomaly Detection | 10.40% | — | 12.82% | 15.56% | — | 10.97% | 7.21% | — | 6.06% |
| Avg Gain (Per Task) | 14.96% | 1.56% | 11.69% | 9.76% | 1.76% | 7.32% | 13.33% | −1.91% | 6.80% |
| Avg Gain (All Tasks, | M-F1: 12.69% | | | MAE: 0.47% | | | ACC: 8.60% | | |
| All Datasets) | | | | | | | | | |

Similarly, Table 7 demonstrates an average increase of 13.55% in Macro-F1 when using Stochastic Soft Prompting instead of finetuning techniques like QLORA. Table 7 shows comparison of LASTS+StoP with LASTS+QLORA. This table shows the percentage improvement in each metric achieved by using Stochastic Soft Prompting compared to finetuning via QLORA. Significant gains are observed across all datasets and tasks with Stochastic Soft Prompts. On average, across all datasets and tasks, Macro-F1 increases by 13.55%.

| | Breakfast | | | MultiTHUMOS | | | EPIC KITCHEN | | |
|---|---|---|---|---|---|---|---|---|---|
| Task | M-F1 | MAE | ACC | M-FI | MAE | ACC | M-FI | MAE | ACC |
| Forecast | 2.93% | 4.39% | 3.11% | 22.65% | 4.71% | 10.31% | 4.32% | −4.47% | 6.39% |
| Imputation | 22.27% | 1.20% | 9.60% | 3.80% | −5.40% | 3.46% | 61.38% | 0.25% | 25.24% |
| Anomaly Detection | 2.67% | — | 3.40% | 0.70% | — | 1.65% | 1.27% | — | 0.70% |
| Avg Gain (Per Task) | 9.29% | 2.79% | 5.37% | 9.05% | −0.34% | 5.14% | 22.32% | −2.11% | 10.78% |
| Arg Gain (All Tasks, | M-F1: 13.55% | | | MAE: 0.11% | | | ACC: 7.10% | | |
| All Datasets) | | | | | | | | | |

### Scaling to Different LLM Backbone Sizes

Stochastic Soft Prompts (StoP) is trained across different backbone sizes of large language models with consistent improvements in performance as the model size increased. Specifically, experiments are conducted using LLama3.2 models with 1B and 3B parameters, as well as the LLama3-8B Instruct model. These improvements were clear across the Breakfast, MultiThumos, and EPIC KITCHENS datasets and applied to all tasks—forecasting, imputation, and anomaly detection. Notably, Table 8 and FIG. 13 show that macro-F1 scores consistently improve with larger model sizes across all datasets and tasks. Additionally, Mean Absolute Error (MAE) decreased in most cases as the model size increased, further confirming that larger models help Stochastic Soft Prompts perform better by utilizing their enhanced representational power. The performance difference between model sizes is smaller for forecasting tasks since these align with the next-token prediction that LLMs are trained on. However, for harder tasks like imputation and anomaly detection, the improvements are much larger as model size increases.

TABLE 8
Comparison of Macro-F1 and MAE across the Breakfast, MultiThumos, and EPIC KITCHENS
datasets for forecasting, imputation, and anomaly detection as the number of model
parameters varies. The results show that Macro-F1 consistently improves with increasing
model size across all datasets and tasks. In most cases, MAE decreases as model size
increases, confirming that larger models generally lead to better performance.

| | | Breakfast | | MultiThumos | | EPIC KITCHEN | |
|---|---|---|---|---|---|---|---|
| | # Params | Macro F1 ↑ | MAE ↓ | Macro F1 ↑ | MAE ↓ | Macro F1 ↑ | MAE ↓ |
| Forecast | 1B | 0.2292 | 33.9309 | 0.3210 | 1.8013 | 0.0574 | 3.0859 |
| | 3B | 0.2526 | 33.2541 | 0.3694 | 1.7259 | 0.0708 | 3.0169 |
| | 8B | 0.2633 | 32.5464 | 0.3947 | 1.6503 | 0.0797 | 3.0318 |
| Imputation | 1B | 0.0256 | 31.1075 | 0.0907 | 2.4256 | 0.0102 | 3.2571 |
| | 3B | 0.0966 | 31.1597 | 0.1329 | 2.3963 | 0.0280 | 3.1445 |
| | 8B | 0.2064 | 28.2251 | 0.2213 | 2.3445 | 0.0610 | 3.1116 |
| Anomaly | 1B | 0.0688 | — | 0.0954 | — | 0.0318 | — |
| Detection | 3B | 0.5726 | — | 0.4777 | — | 0.5793 | — |
| | 8B | 0.7198 | — | 0.6045 | — | 0.6603 | — |

### Few Shot

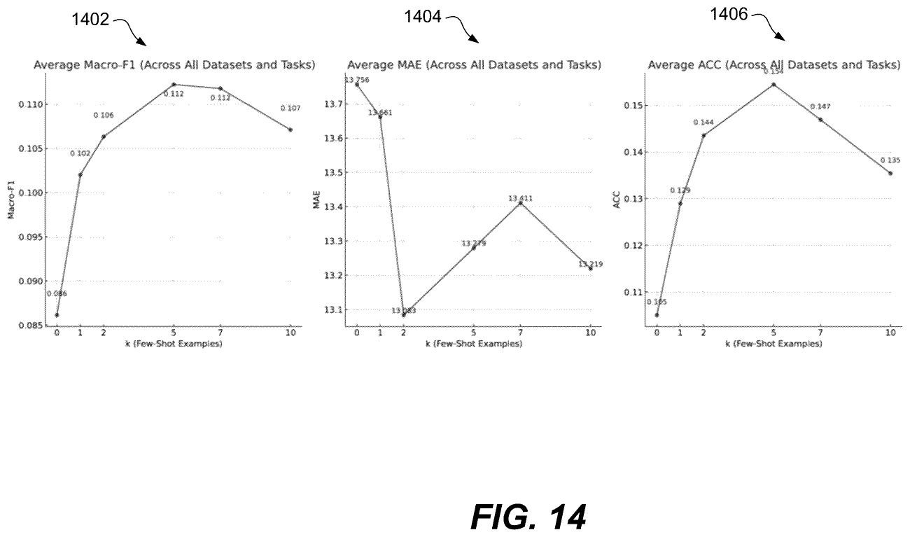

The impact of varying the number of examples (k) in the few-shot setting is studied to determine the optimal value of k. Specifically, the performance of LASTS few shot is evaluated on all datasets and tasks using different k values, ranging from k=0 (zero shot) to k=10. As shown in FIG. 14 and detailed in Table 9, the performance metrics: Macro-F1, MAE, and ACC, improve significantly as k increases from 0 to 5. However, further increases in k beyond 5 do not consistently yield improvements and, in some cases, result in marginal performance degradation. On average, k=5 achieves the best balance across all metrics and datasets. Therefore, k=5 is used as the default value for LASTS few shot.

FIG. 14 depicts average values of Macro-F1 (1402), MAE (1404), and ACC (1406) across all datasets and tasks for different values of k (number of few-shot examples). Higher values indicate better performance for Macro-F1 and ACC, while lower values indicate better performance for MAE. The results indicate that on an average, k=5 works best.

TABLE 9
Comparison of performance metrics (M-F1, MAE, and ACC) across Breakfast, MultiTHUMOS
and EPIC KITCHEN datasets over forecast, imputation and anomaly detection
tasks for different few-shot values k given as in-context examples.

| | Breakfast | | | MultiTHUMOS | | | EPIC-KITCHENS | | |
|---|---|---|---|---|---|---|---|---|---|
| Few-Shot (k) | M-F1 ↑ | MAE ↓ | ACC ↑ | M-F1 ↑ | MAE ↓ | ACC ↑ | M-F1 ↑ | MAE ↓ | ACC ↑ |
| | Forecast | | | | | | | | |
| k = 0 | 0.0604 | 38.1630 | 0.0969 | 0.1361 | 1.8868 | 0.1826 | 0.0105 | 3.1566 | 0.0920 |
| k = 1 | 0.1312 | 37.6239 | 0.1808 | 0.1393 | 1.7913 | 0.2381 | 0.0144 | 3.2606 | 0.1123 |
| k = 2 | 0.1257 | 36.4688 | 0.1870 | 0.1622 | 1.7960 | 0.2505 | 0.0151 | 3.2266 | 0.1180 |
| k = 5 | 0.1518 | 35.5605 | 0.2133 | 0.1676 | 1.8114 | 0.2581 | 0.0149 | 3.3092 | 0.1150 |
| k = 7 | 0.1491 | 35.6785 | 0.2107 | 0.1991 | 1.7810 | 0.2828 | 0.0138 | 3.2177 | 0.1002 |
| k =10 | 0.1667 | 37.6084 | 0.2442 | 0.1807 | 1.7820 | 0.2397 | 0.0124 | 3.0904 | 0.0901 |
| | Imputation | | | | | | | | |
| k = 0 | 0.0263 | 33.0097 | 0.0594 | 0.0915 | 2.6696 | 0.1210 | 0.0015 | 3.6527 | 0.0446 |
| k = 1 | 0.0419 | 33.1403 | 0.0738 | 0.1165 | 2.5106 | 0.1490 | 0.0018 | 3.6402 | 0.0569 |
| k = 2 | 0.0527 | 31.1138 | 0.0826 | 0.1102 | 2.3576 | 0.1486 | 0.0022 | 3.5375 | 0.0527 |
| k = 5 | 0.0520 | 33.3440 | 0.1001 | 0.1013 | 2.3982 | 0.1569 | 0.0023 | 3.2528 | 0.0547 |
| k = 7 | 0.0509 | 34.0198 | 0.0994 | 0.1001 | 2.4228 | 0.1462 | 0.0019 | 3.3447 | 0.0475 |
| k = 10 | 0.0474 | 31.2001 | 0.1069 | 0.1219 | 2.3771 | 0.1546 | 0.0015 | 3.2552 | 0.0406 |
| | Anomaly Detection | | | | | | | | |
| k = 0 | 0.0923 | — | 0.0763 | 0.2755 | — | 0.1949 | 0.0159 | — | 0.0777 |
| k = 1 | 0.1002 | — | 0.0681 | 0.2809 | — | 0.1961 | 0.0172 | — | 0.0854 |
| k = 2 | 0.0739 | — | 0.0569 | 0.3361 | — | 0.2891 | 0.0213 | — | 0.1062 |
| k = 5 | 0.0837 | — | 0.0563 | 0.3535 | — | 0.2720 | 0.0337 | — | 0.1637 |
| k = 7 | 0.0705 | — | 0.0469 | 0.3436 | — | 0.2516 | 0.0278 | — | 0.1369 |
| k = 10 | 0.1026 | — | 0.0700 | 0.2340 | — | 0.1629 | 0.0222 | — | 0.1097 |

k = 0 indicates zero shot.
Higher M-F1 and ACC values indicate better performance, while lower MAE values are better. MAE computation is not applicable for anomaly detection.
Best metric values are indicated in bold.

### Analysis on Stochastic Soft Prompts (StoP)

The structure learned by StoP prompts and the practical benefits of Stochastic Soft Prompts are described below.

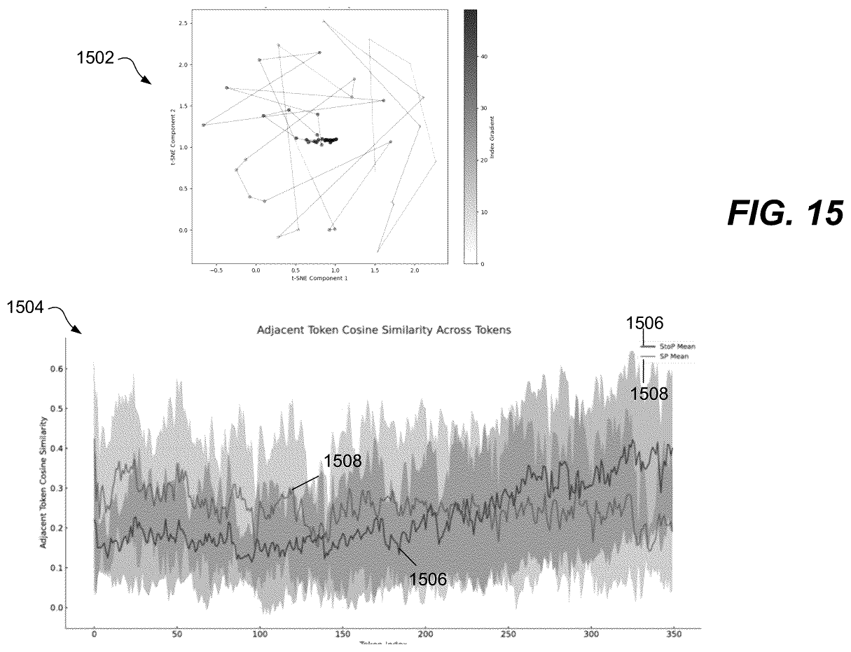

Evidence for Coarse-to-Fine Structure. In FIG. 15, 1502 shows t-SNE projections of StoP tokens with a prompt length of 50 on the Breakfast dataset for the forecasting task. Adjacent tokens are connected by a line, and the color darkens as the token index increases. The presence of lighter tokens on the periphery and darker tokens in the center indicates that the initial tokens learn very diverse information, while this diversity diminishes as the token index increases. 1504 shows pairwise cosine similarity of the first 350 tokens of a stochastic soft prompt and a soft prompt learned on the Breakfast dataset for forecasting. In StoP, the initial cosine similarities are smaller and increase as the token index increases, while no such variation by token index is present in a normal soft prompt. In 1504, the results for StoP (1506) are plotted in blue, which appears as a darker shade in greyscale, and the results for SP (1508) are plotted in red, which appears as a lighter shade in greyscale.

The prompts learned through Stochastic Soft Prompts (StoP) suggest the presence of a structured coarse-to-fine hierarchy. In this structure, the first few tokens appear to encode broader task-level information, while later tokens may refine predictions by adding more detailed nuances. Example observations that support this behavior are shown below:
1. t-SNE Projections: Visualizations of t-SNE projections (see FIG. 15) suggest that the first few tokens in StoP prompts may encode more diverse or independent representations, as indicated by their wider spread in the projection space. In contrast, the later tokens tend to cluster more closely together, potentially reflecting the refinement of previously encoded information.
2. Cosine Similarity: Adjacent tokens at the beginning of the StoP prompt tend to exhibit lower cosine similarity compared to tokens later in the prompt (see FIG. 15). This pattern suggests more diverse information being captured at the beginning of the prompt. Standard soft prompts, however, show uniformly high cosine similarities across all tokens, lacking this structure.
3. Prefix Validity: FIG. 10 indicates that any prefix of a StoP prompt can serve as a valid standalone prompt, with additional tokens refining the predictions. This behavior suggests that early tokens convey broad task-level information, while later tokens refine and add finer-grained details

StoP can offer many benefits over standard soft prompting:
1. Improved Generalization: StoP prompts can achieve better generalization compared to standard soft prompts, with an average improvement of 12.69% in Macro-F1 across all datasets (Breakfast, MultiTHUMOS, and EPIC KITCHENS) and tasks (Forecast, Imputation, Anomaly Detection) (see Table 6).
2. Faster Training: The stochastic nature of StoP can reduce training time by approximately 25%, making it more efficient than standard soft prompting.
3. Resource Efficiency: StoP can enable flexible deployment in resource-constrained environments. Longer trained StoP prompts can be truncated to prefixes as needed, allowing for adaptable inference without compromising performance.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the foregoing description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Hilde Kuehne, Ali Arslan, and Thomas Serre. The language of actions: Recovering the syntax and semantics of goal-directed human activities. In IEEE Conference on Computer Vision and Pattern Recognition (CVPR), 2014.
[2] Dima Damen, Hazel Doughty, Giovanni Maria Farinella, Antonino Furnari, Jian Ma, Evangelos Kazakos, Davide Moltisanti, Jonathan Munro, Toby Perrett, Will Price, and Michael Wray. Rescaling Egocentric Vision: Collection, Pipeline and Challenges for EPIC-KITCHENS-100. International Journal of Computer Vision (IJCV), 2022.
[3] Serena Yeung, Olga Russakovsky, Ning Jin, Mykhaylo Andriluka, Greg Mori, and Li Fei-Fei. Every moment counts: Dense detailed labeling of actions in complex videos. IEEE International Conference on Computer Vision (ICCV), 2018.
[4] Siqiao Xue, Xiaoming Shi, Zhixuan Chu, Yan Wang, Fan Zhou, Hongyan Hao, Caigao Jiang, Chen Pan, Yi Xu, James Y Zhang, et al. EasyTPP: Towards Open Benchmarking the Temporal Point Processes. International Conference on Learning Representations (ICLR), 2024.
[5] Jianmo Ni, Jiacheng Li, and Julian McAuley. Justifying recommendations using distantly-labeled reviews and fine-grained aspects. In Proceedings of the conference on empirical methods in natural language processing and the international joint conference on natural language processing (EMNLP-IJCNLP), 2019.
[6] Ke Zhou, Hongyuan Zha, and Le Song. Learning triggering kernels for multi-dimensional Hawkes processes. In International Conference on Machine Learning (ICML), 2013.
[7] Chris Whong. FOILing NYC's Taxi Trip Data. Available at: https://chriswhong.com/open-data/foil_nyc_taxi/, 2014.
[8] Siqiao Xue, Xiaoming Shi, James Zhang, and Hongyuan Mei. Hypro: A hybridly normalized probabilistic model for long-horizon prediction of event sequences. Advances in Neural Information Processing Systems (NeurIPS), 2022.
[9] JureLeskovec. Standford Large Network Dataset Collection. Available at: https://snap.stanford.edu/data/.
[10] Yiming Yang. An evaluation of statistical approaches to text categorization. Information retrieval, 1999.
[11] Dubey et al. The Llama 3 Herd of Models. In arXiv 2407.21783, 2024.
[12] Nan Du, Hanjun Dai, Rakshit Trivedi, Utkarsh Upadhyay, Manuel Gomez-Rodriguez, and Le Song. Recurrent marked temporal point processes: Embedding event history to vector. New York, NY, USA, 2016. Association for Computing Machinery. ISBN 9781450342322.
[13] Hongyuan Mei and Jason M Eisner. The neural hawkes process: A neurally self-modulating multi¬variate point process. In I. Guyon, U. Von Luxburg, S. Bengio, H. Wallach, R. Fergus, S. Vish-wanathan, and R. Garnett (eds.), Advances in Neural Information Processing Systems, volume 30. Curran Associates, Inc., 2017.
[14] Qiang Zhang, Aldo Lipani, Omer Kirnap, and Emine Yilmaz. Self-attentive Hawkes process. In International Conference on Machine Learning (ICML), 2020.
[15] Simiao Zuo, Haoming Jiang, Zichong Li, Tuo Zhao, and Hongyuan Zha. Transformer Hawkes process. In International Conference on Machine Learning (ICML), 2020.
[16] Xi Yang, Aokun Chen, Nima PourNejatian, Hoo Chang Shin, Kaleb E Smith, Christopher Parisien, Colin Compas, Cheryl Martin, Anthony B Costa, Mona G Flores, et al. A large language model for electronic health records. NPJ digital medicine, 2022.
[17] Ansari, A. F., Stella, L., Turkmen, C., Zhang, X., Mercado, P., Shen, H., Shchur, O., Rangapuram, S. S., Arango, S. P., Kapoor, S., et al. Chronos: Learning the language of time series. Transactions on Machine Learning Research https://openreview.net/forum?id=gerNCVqqtR, 2024.
[18] Gruver, N., Finzi, M., Qiu, S., and Wilson, A. G. Large language models are zero-shot time series forecasters. Advances in Neural Information Processing Systems, 36, 2024.
[19] Requeima, J., Bronskill, J. F., Choi, D., Turner, R. E., and Duvenaud, D. Llm processes: Numerical predictive distributions conditioned on natural language. In ICML 2024 Workshop on In-Context Learning, 2024.

1. A computer-implemented method, comprising:
obtaining an asynchronous time series of event data, the asynchronous time series comprising events and corresponding times associated with the events;
processing the asynchronous time series of event data to generate an input series comprising a textual description of each of the events and a time associated with each of the events;
generating a prompt to a large language model, the prompt comprising the input series and specifying a task to be performed on the input series; and
receiving an output from the large language model in response to the prompt.

2. The computer-implemented method of claim 1, wherein the time associated with a particular event in the input series comprises an inter-arrival time between the particular event and a previous event.

3. The computer-implemented method of claim 1, wherein the input series is expressed as a sequence of pairs.

4. The computer-implemented method of claim 3, wherein the time is presented first in the pair, followed by the textual description of the event.

5. The computer-implemented method of claim 1, wherein the task to be performed on the input series is one of: forecasting, data imputation, and anomaly detection.

6. The computer-implemented method of claim 1, wherein generating the prompt comprises prepending a prefix obtained from a trained prompt.

7. The computer-implemented method of claim 6, further comprising obtaining the trained prompt by:
obtaining training data for training the large language model;
obtaining a trainable prompt having a prefix;
generating a training prompt comprising the training data and a randomly selected prefix from the prefix of the trainable prompt; and
training the large language model and the trainable prompt using the training prompt.

8. The computer-implemented method of claim 1, wherein the asynchronous time series of event data comprises customer interactions with a financial institution.

9. The computer-implemented method of claim 1, wherein the asynchronous time series of event data comprises events associated with a financial account.

10. The computer-implemented method of claim 1, further comprising generating an alert based on the output from the large language model.

11. A computer-implemented method, comprising:
obtaining training data for training a large language model;
obtaining a trainable prompt having a prefix for training the large language model to perform a task;
generating a training prompt comprising the training data and a randomly selected prefix from the prefix of the trainable prompt; and
training the large language model and the trainable prompt using the training prompt.

12. The computer-implemented method of claim 11, wherein the randomly selected prefix is obtained by selecting a particular prefix length from a prefix length of the trainable prompt using a probability distribution of prefix lengths.

13. The computer implemented method of claim 12, wherein the probability distribution is a uniform distribution.

14. The computer-implemented method of claim 11, wherein the task that the large language model is trained to perform is one of: forecasting, data imputation, and anomaly detection.

15. The computer-implemented method of claim 11, wherein the training data comprises an asynchronous time series of event data.

16. A system, comprising:
a processor; and
a non-transitory computer-readable medium having computer-executable instructions stored thereon which, when executed by the processor, configure the system to perform a computer-implemented method comprising:
obtaining an asynchronous time series of event data, the asynchronous time series comprising events and corresponding times associated with the events;
processing the asynchronous time series of event data to generate an input series comprising a textual description of each of the events and a time associated with each of the events;
generating a prompt to a large language model, the prompt comprising the input series and specifying a task to be performed on the input series; and
receiving an output from the large language model in response to the prompt.

17. The system of claim 16, wherein the time associated with a particular event in the input series comprises an inter-arrival time between the particular event and a previous event.

18. The system of claim 16, wherein the input series is expressed as a sequence of pairs.

19. The system of claim 16, wherein the task to be performed on the input series is one of: forecasting, data imputation, and anomaly detection.

20. The system of claim 16, wherein generating the prompt comprises prepending a prefix obtained from a trained prompt.
